(19) United States
(12) Patent Application Publication
(10) Pub. No.: US 2022/0314704 A1
(43) Pub. Date: Oct. 6, 2022

(54) PNEUMATIC TIRE

(71) Applicant: The Yokohama Rubber Co., LTD., Tokyo (JP)

(72) Inventor: Masatoshi SHIMIZU, Kanagawa (JP)

(21) Appl. No.: 17/597,979

(22) PCT Filed: Jul. 15, 2020
(86) PCT No.: PCT/JP2020/027539

§ 371 Date: Jan. 31, 2022

(30) Foreign Application Priority Data
Aug. 5, 2019 (JP) 2019-143980
Aug. 5, 2019 (JP) 2019-144015

(51) Int. Cl. B60C 13/02

(52) U.S. Cl. CPC B60C 13/023

(57) ABSTRACT

A pneumatic tire includes a serration region provided in a predetermined region of a sidewall portion, the serration region being formed by arranging a plurality of ridges, the plurality of ridges protruding from a base surface in parallel to each other and periodically, when a length along a contour of the ridge per cycle in a cross-sectional view along a direction orthogonal to an extension direction of the plurality of ridges is defined as a length Lr and a length of one cycle of the plurality of ridges along the base surface is defined as a length Lb, a ratio (Lr/Lb) of the length Lr to the length being 1.2 or more and 2.0 or less, and the length Lb being 0.5 mm or more and 0.7 mm or less.

### TECHNICAL FIELD

The present technology relates to a pneumatic tire.

### BACKGROUND ART

An indicator of a brand or the like may be attached to a tire side portion of a pneumatic tire. In order to improve the visibility and appearance of the indicator of the brand or the like, there is a demand for tires with high self-cleaning performance that can easily wash away the deposits on the tire side portions by rain or cleaning the vehicle. If an organic cleaning agent is used, cracks may occur due to deterioration of a side rubber, and it is necessary to improve the cleaning performance with only water. From the perspective of taking into consideration the influence on the environment due to the outflow of the cleaning agent, a tire having high cleaning performance only with water without using a cleaning agent is useful.

Japan Patent No. 3422715 discloses a pneumatic tire in which the visibility of a decorative portion provided on a sidewall portion is enhanced. Japan Patent No. 4371625 discloses a pneumatic tire in which a ridge is provided on a sidewall portion to suppress deterioration of appearance due to cracks occurring on a rubber surface.

Japan Patent Nos. 3422715 and 4371625 do not take both the visibility performance and the cleaning performance into consideration, and there is room for improvement in both the visibility performance and the cleaning performance.

### SUMMARY

The present technology provides a pneumatic tire capable of enhancing both visibility performance and cleaning performance.

A pneumatic tire according to an aspect of the present technology is a pneumatic tire including a tread portion, a sidewall portion, and a bead portion, a serration region being provided in a predetermined region of the sidewall portion, the serration region being formed by arranging a plurality of ridges, the plurality of ridges protruding from a base surface in parallel to each other and periodically, when a length along a contour of the ridge per cycle in a cross-sectional view along a direction orthogonal to an extension direction of the plurality of ridges is defined as a length Lr and a length of one cycle of the plurality of ridges along the base surface is defined as a length Lb, a ratio Lr/Lb of the length Lr to the length Lb being 1.2 or more and 2.0 or less, and the length Lb being 0.5 mm or more and 0.7 mm or less.

Preferably, an opening width La between the ridges that are adjacent is 0.15 mm or more and 0.35 mm or less, in a cross-sectional view along a direction orthogonal to an extension direction of the ridge.

Preferably, a ratio La/Lb of the opening width La to the length Lb is 0.3 or more and 0.6 or less.

A pneumatic tire includes a tread portion, a sidewall portion, and a bead portion, a serration region being provided in a predetermined region of the sidewall portion, the serration region being formed by arranging a plurality of ridges, the plurality of ridges protruding from a base surface in parallel to each other and periodically, a length Lb of one cycle of the plurality of ridges along the base surface being 0.5 mm or more and 0.7 mm or less, in a cross-sectional view along a direction orthogonal to an extension direction of the plurality of ridges, a plurality of recess portions being provided on a top surface of each of the plurality of ridges, a bottom flat portion with no unevenness being provided on a bottom surface of the recess portion, an inter-recess flat portion with no unevenness being provided between the recess portions that are adjacent, and a ratio H2/H1 of a height H2 from the base surface to the inter-recess flat portion to a height H1 from the base surface to the bottom flat portion being 1.2 or more and 1.6 or less.

Preferably, when a length along a contour of the ridge per cycle in a cross-sectional view along a direction orthogonal to an extension direction of the plurality of ridges is defined as a length Lr, a ratio Lr/Lb of the length Lr to the length Lb is 1.2 or more and 2.0 or less.

Preferably, in a cross-sectional view along a direction orthogonal to an extension direction of the ridge, a ratio W2/W1 of an opening width W2 of the top surface of the recess portion to a width W1 of the top surface of the ridge is 0.1 or more and 0.3 or less, and a ratio W3/W1 of a width W3 of the recess portion to the width W1 of the top surface of the ridge is 0.05 or more and 0.25 or less.

Preferably, a difference between a height H1 from the base surface to the bottom flat portion and a height H3 from the base surface to a maximum height position of the top surface of the ridge is 0.03 mm or more and 0.15 mm or less.

Preferably, a ratio (H2−H1)/(H3−H1) of a difference between a height H2 from the base surface to the inter-recess flat portion and a height H1 from the base surface to the bottom flat portion to a difference between a height H3 from the base surface to a maximum height position of the top surface of the ridge and the height H1 from the base surface to the bottom flat portion is 0.2 or more and 0.6 or less.

Preferably, the base surface includes a flat portion having no unevenness, the flat portion is a straight line in a cross-sectional view along a direction orthogonal to an extension direction of the ridge, and a length of the straight line is 0.15 mm or more.

Preferably, a ratio RH/Lb, to the length Lb, of a height RH from the base surface to a maximum projection position of the ridge is 0.11 or more and 0.3 or less.

Preferably, in a tire meridian cross-section, a ratio LH/SH, to a tire cross-sectional height SH, of a length LH in a tire radial direction of a range in the tire radial direction of the serration region is 0.2 or more and 0.4 or less.

Preferably, in a tire meridian cross-section, when a height along a tire radial direction from a measurement point of a rim diameter of a rim on which the pneumatic tire is mounted to a position on an inner side of the serration region in the tire radial direction is defined as AH, a ratio AH/SH of the height AH to a tire cross-sectional height SH is 0.3 or more and 0.5 or less.

Preferably, an angle θr between a flat portion of the base surface having no unevenness and a wall surface of the ridge is 60° or more and 85° or less.

Preferably, an angle θc in an extension direction of the ridge with respect to a tire radial direction is within a range of ±20° with respect to the tire radial direction.

Preferably, the surface of the member forming the contour of the ridge has a hydrophilic property.

Preferably, an arithmetic mean roughness Ra of rubber on a surface of the ridge is 0.1 μm or more and 5 μm or less.

Preferably, the base surface is a surface recessed from the tire profile toward a tire cavity side.

Preferably, the pneumatic tire further includes a first protrusion portion extending in a tire circumferential direction at a position on an outer side of the serration region in a tire radial direction, and a second protrusion portion extending in the tire circumferential direction at a position on an inner side of the serration region in the tire radial direction.

Preferably, the protrusion height of the first protrusion portion and the second protrusion portion from a tire profile is 0.7 mm or less.

Preferably, the ridge is trapezoidal in a cross-sectional view along a direction orthogonal to an extension direction of the ridge.

According to the pneumatic tire according to the present technology, both the visibility performance and the cleaning performance can be improved.

### BRIEF DESCRIPTION OF DRAWINGS

FIG. 1 is a meridian cross-sectional diagram illustrating a main portion of a pneumatic tire according to an embodiment.

FIG. 2 is a side diagram of a pneumatic tire according to an embodiment of the present technology.

FIG. 3 is a cross-sectional diagram illustrating an example of a ridge provided in a serration region in FIG. 2.

FIG. 4 is a cross-sectional diagram illustrating an example of a ridge provided in a serration region in FIG. 2.

FIG. 5 is a diagram illustrating the hydrophilic property of the surface of a member forming the contour of a ridge.

FIG. 6 is a diagram illustrating the hydrophilic property of the surface of a member forming the contour of a ridge.

FIG. 7 is a diagram illustrating an enlarged view of a portion of FIG. 4.

FIG. 8 is a cross-sectional diagram illustrating an example of a ridge provided in a serration region in FIG. 2.

FIG. 9 is a cross-sectional diagram illustrating an example of a ridge provided in a serration region in FIG. 2.

FIG. 10 is a cross-sectional diagram illustrating an example of a ridge provided in a serration region in FIG. 2.

FIG. 11 is a cross-sectional diagram illustrating an example of a ridge provided in a serration region in FIG. 2.

FIG. 12 is a cross-sectional diagram illustrating an example of adjacent ridges.

FIG. 13 is a cross-sectional diagram illustrating an example of adjacent ridges.

FIG. 14 is a cross-sectional diagram illustrating an example of adjacent ridges.

FIG. 15 is a cross-sectional diagram illustrating an example of adjacent ridges.

FIG. 16 is a diagram illustrating an enlarged view of a portion of FIG. 12.

FIG. 17 is a diagram illustrating the hydrophilic property of the surface of a member forming the contour of each ridge.

FIG. 18 is a diagram illustrating an example of a serration region.

FIG. 19 is a diagram illustrating an example of a serration region.

FIG. 20 is a diagram illustrating an example of a serration region.

FIG. 21 is a diagram illustrating an example of a serration region.

FIG. 22 is a diagram illustrating a length of a recess portion provided in a ridge.

FIG. 23 is a diagram illustrating a length of a recess portion provided in a ridge.

FIG. 24 is a diagram illustrating an example of the arrangement of ridges in a serration region.

FIG. 25 is a diagram illustrating an example of the arrangement of ridges in a serration region.

FIG. 26 is a diagram illustrating an example of the shape of a ridge.

FIG. 27 is a diagram illustrating an example of the shape of a ridge.

### DETAILED DESCRIPTION

Embodiments of the present technology are described in detail below with reference to the drawings. In the embodiments described below, identical or substantially similar components to those of other embodiments have identical reference signs, and descriptions of those components are either simplified or omitted. The present technology is not limited by the embodiments. Constituents of the embodiments include elements that are substantially identical or that can be substituted and easily conceived by one skilled in the art. Furthermore, the plurality of modified examples described in the embodiments can be combined as desired within the scope apparent to one skilled in the art.

In the following description, a meridian cross-section of a tire is defined as a cross-section when a tire is cut in a plane including a rotation axis (not illustrated) of the tire. “Tire width direction” refers to the direction parallel to the rotation axis (not illustrated) of a pneumatic tire 1. “Outer side in the tire width direction” refers to the side away from a tire equatorial plane (tire equator line) in the tire width direction. “Tire circumferential direction” refers to the circumferential direction with the rotation axis as the center axis. “Tire radial direction” refers to the direction orthogonal to the rotation axis. “Inner side in the tire radial direction” refers to the side toward the rotation axis in the tire radial direction. “Outer side in the tire radial direction” refers to the side away from the rotation axis in the tire radial direction. “Tire equatorial plane” is the plane orthogonal to the rotation axis that passes through the center of the tire width of the pneumatic tire 1. “Tire width” is the width in the tire width direction between components located on the outer side in the tire width direction, or in other words, the distance between the components that are the most distant from the tire equatorial plane in the tire width direction. Furthermore, “tire equator line” refers to the line in the circumferential direction of the pneumatic tire 1 that lies on the tire equatorial plane.

### Pneumatic Tire

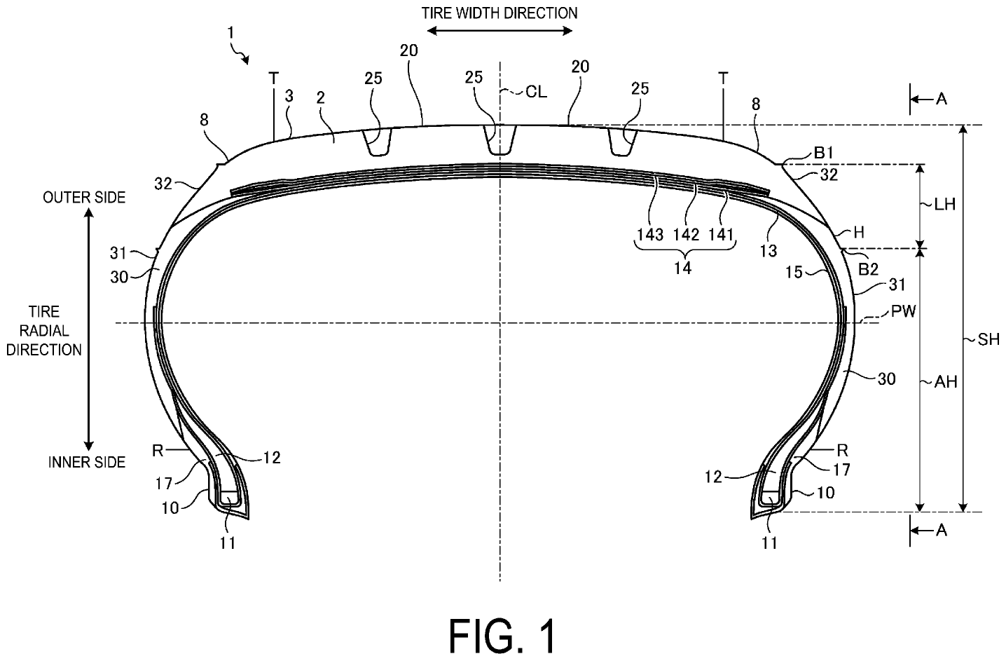

FIG. 1 is a meridian cross-sectional diagram illustrating a main portion of a pneumatic tire according to an embodiment. In the pneumatic tire 1 illustrated in FIG. 1, a tread portion 2 is arranged at the outermost portion in the tire radial direction when viewed in a meridian cross-section. The surface of the tread portion 2, that is, the portion that comes into contact with the road surface during traveling of a vehicle (not illustrated) mounted with the pneumatic tire 1, includes a tread surface 3. A plurality of circumferential main grooves 25 extending in the tire circumferential direction are formed in the tread surface 3. A plurality of land portions 20 are defined in the tread surface 3 by the circumferential main grooves 25. Grooves other than the circumferential main grooves 25 may be formed in the tread surface 3. For example, lug grooves (not illustrated) extending in the tire width direction, narrow grooves (not illustrated) different from the circumferential main grooves 25, and the like may be formed in the tread surface 3.

Shoulder portions 8 are located at both ends of the tread portion 2 in the tire width direction. Sidewall portions 30 are arranged on an inner side of the shoulder portion 8 in the tire radial direction. The sidewall portions 30 are arranged at two locations on both sides of the pneumatic tire 1 in the tire width direction. The surface of the sidewall portion 30 is formed as a tire side portion 31. The tire side portions 31 are located on both sides in the tire width direction. The two tire side portions 31 each face an opposite side of a side in the tire width direction where the tire equatorial plane CL is located.

In this case, the tire side portion 31 refers to a surface that uniformly continues in a range on the outer side in the tire width direction from a ground contact edge T of the tread portion 2 and on the outer side in the tire radial direction from a rim check line R. Further, the ground contact edge T refers to both outermost edges in the tire width direction of a region in which the tread surface 3 of the tread portion 2 of the pneumatic tire 1 contacts the road surface with the pneumatic tire 1 assembled on a regular rim, inflated to the regular internal pressure, and loaded with 70% of the regular load. The ground contact edge T is continuous in the tire circumferential direction. Moreover, the rim check line R refers to a line used to confirm whether the tire has been mounted on the rim correctly and, typically, on a front side surface of bead portions 10, the rim check line R is closer to the outer side in the tire radial direction than a rim flange (not illustrated) and is an annular convex line continuing in the tire circumferential direction along a portion approximate to the rim flange.

The non-ground contact region of the connection portion between the profile of the tread portion 2 and the profile of the sidewall portion 30 is called a buttress portion. A buttress portion 32 constitutes a side wall surface on an outer side of the shoulder portion 8 in the tire width direction.

Note that “regular rim” refers to an “applicable rim” defined by the Japan Automobile Tyre Manufacturers Association (JATMA), a “Design Rim” defined by the The European Tyre and Rim Technical Organisation, Inc. (TRA), or a “Measuring Rim” defined by the European Tyre and Rim Technical Organisation (ETRTO). Additionally, “regular internal pressure” refers to a “maximum air pressure” defined by JATMA, the maximum value in “TIRE LOAD LIMITS AT VARIOUS COLD INFLATION PRESSURES” defined by TRA, or “INFLATION PRESSURES” defined by ETRTO. Additionally, “regular load” refers to a “maximum load capacity” defined by JATMA, a maximum value in “TIRE LOAD LIMITS AT VARIOUS COLD INFLATION PRESSURES” defined by TRA, or “LOAD CAPACITY” defined by ETRTO.

The bead portion 10 is located on an inner side of each of the sidewall portions 30 in the tire radial direction located on both sides in the tire width direction. The bead portions 10 are arranged at two locations on both sides of the tire equatorial plane CL, similarly to the sidewall portions 30. Each bead portion 10 is provided with a bead core 11, and a bead filler 12 is provided on an outer side in the tire radial direction of the bead core 11.

A plurality of belt layers 14 are provided on an inner side of the tread portion 2 in the tire radial direction. The belt layers 14 include a plurality of cross belts 141, 142 and a belt cover 143 and form a multilayer structure. Of these, the cross belts 141 and 142 are formed by performing a rolling process on a plurality of coating rubber-covered belt cords made of steel or an organic fiber material. The cross belts 141 and 142 have a belt angle of 20° or more and 55° or less in absolute value. Furthermore, the belt cords of the cross belts 141, 142 have different set inclination angles of the fiber direction of the belt cords with respect to the tire circumferential direction, and the belts are layered so that the fiber directions of the belt cords intersect each other, i.e., a crossply structure. The belt cover 143 is formed by performing a rolling process on coating rubber-covered steel or a plurality of cords made of an organic fiber material. The belt cover 143 has a belt angle of 0° or more and 10° or less in absolute value. The belt cover 143 is disposed in a layered manner an outer side of the cross belts 141, 142 in the tire radial direction.

A carcass 13 containing the cords of radial plies is continuously provided on an inner side in the tire radial direction of the belt layer 14 and on a side of the sidewall portion 30 close to the tire equatorial plane CL. The carcass 13 has a single layer structure made of one carcass ply or a multilayer structure made of a plurality of layered carcass plies. The carcass 13 spans the bead cores 11 disposed on both sides in the tire width direction in a toroidal shape, forming the backbone of the tire. Specifically, the carcass 13 is disposed to span from one bead portion 10 to the other bead portion 10 among the bead portions 10 located on both sides in the tire width direction and turns back toward the outer side in the tire width direction along the bead cores 11 at the bead portions 10 so as to wrap around the bead cores 11 and the bead fillers 12. The carcass ply of the carcass 13 is formed by performing a rolling process on a plurality of coating rubber-covered carcass cords made of steel or an organic fiber material, such as aramid, nylon, polyester, rayon, and the like. The carcass ply has a carcass angle of 80° or more and 95° or less in absolute value, the carcass angle being an inclination angle of the fiber direction of the carcass cords with respect to the tire circumferential direction.

At the bead portion 10, a rim cushion rubber 17 is disposed on the inner side in the tire radial direction and the outer side in the tire width direction of the bead core 11 and a turned back portion of the carcass 13, the rim cushion rubber 17 forming a contact surface of the bead portion 10 against the rim flange. Additionally, an innerliner 15 is formed along the carcass 13 on an inner side of the carcass 13 or on an inner portion side of the carcass 13 in the pneumatic tire 1.

### Serration Region

In FIG. 1, the pneumatic tire 1 includes a protrusion portion B1 and a protrusion portion B2 on the buttress portion 32. A serration region H is defined between the protrusion portion B1 and the protrusion portion B2. The serration region H is located on an outer side of a maximum width position PW of the pneumatic tire 1 in the tire radial direction. The serration region H is formed by arranging a plurality of ridges as described later, and the plurality of ridges are arranged parallel to each other and periodically. A ratio LH/SH of a length LH in the tire radial direction in the range in the tire radial direction of the serration region H to a tire cross-sectional height SH is 0.2 or more and 0.4 or less.

Further, when a height along the tire radial direction from a measurement point of the rim diameter of the rim (not illustrated) on which the pneumatic tire 1 is mounted, to a position on an inner side of the serration region H in the tire radial direction is defined as AH, a ratio AH/SH of the height AH to the tire cross-sectional height SH is 0.3 or more and 0.5 or less.

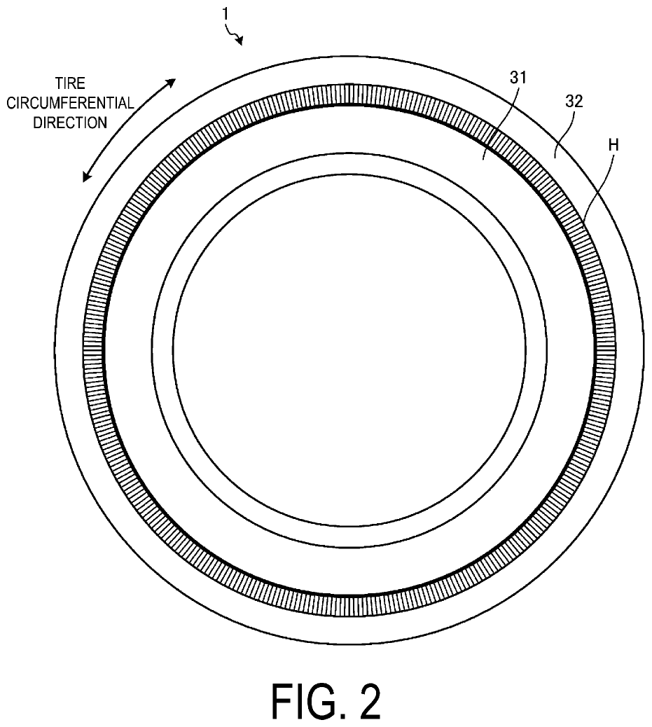

FIG. 2 is a side diagram of the pneumatic tire 1 according to an embodiment of the present technology. FIG. 2 is a side diagram of the pneumatic tire 1 including the view taken along an arrow A-A of FIG. 1. In FIG. 2, the serration region H is provided on the tire side portion 31.

The tire side portion 31 may be provided with a decorative portion for the purpose of improving the appearance of the pneumatic tire 1 and displaying various kinds of information. The decorative portion may include various kinds of information such as a brand name, a logo mark, or a product name for identifying the pneumatic tire 1 or for illustrating those to users.

### Cross-Sectional Shape of Ridge

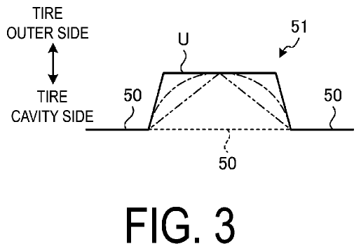

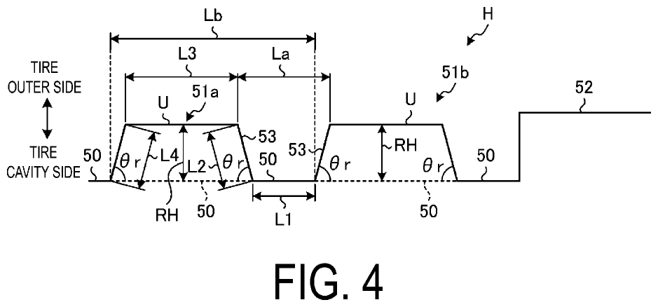

FIGS. 3 and 4 are cross-sectional diagrams illustrating an example of a ridge provided in the serration region H in FIG. 2. FIGS. 3 and 4 are cross-sectional diagrams taken along a direction orthogonal to the extension direction of the ridge. FIG. 3 is a cross-sectional diagram illustrating an example of one ridge 51. FIG. 4 is a cross-sectional diagram illustrating an example of adjacent ridges 51a and 51b.

In FIG. 3, the ridge 51 protrudes toward a tire outer side from a base surface 50. The ridge 51 has a mountain ridge-like convex shape and extends along the tire side portion 31. The ridge 51 is substantially trapezoidal in a cross-sectional view along a direction orthogonal to the extension direction. The substantially trapezoidal shape is a shape including a flat portion having no unevenness on the upper bottom, that is, a top surface U. If at least a portion of the top surface U is a flat portion with no unevenness, it may be considered as a substantially trapezoidal shape, and the entire top surface U does not need to be a flat portion with no unevenness. The ridge 51 may be an arc as indicated by the dot-dash line, or may be a triangle as indicated by the two-dot chain line. When the shape of the ridge 51 is trapezoidal in a cross-sectional view along a direction orthogonal to the extension direction, the surface area of the ridge can be increased as compared with other shapes (arc, triangle) even if the height is identical, and the hydrophilic property can be improved. Further, even if it is trapezoidal, since the lower bottom coincides with the base surface 50, water can easily enter the base surface 50 as compared with the case where the upper bottom coincides with the base surface 50, and the hydrophilic property and the cleaning property can be improved.

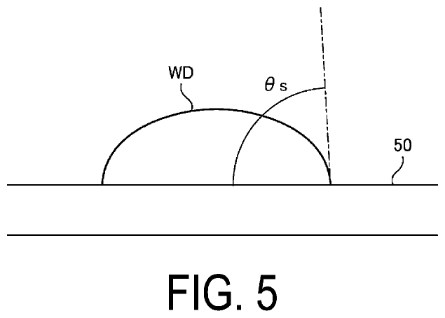

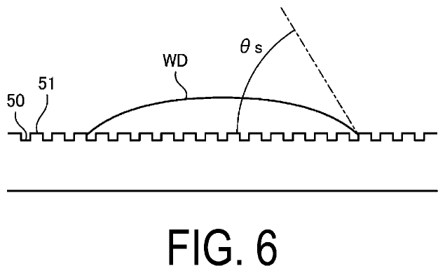

Further, the surface of the member forming the contour of the ridges 51a and 51b has a hydrophilic property. By providing the ridges 51a and 51b on the member having the hydrophilic property, the hydrophilic property can be enhanced. FIGS. 5 and 6 are diagrams for explaining the hydrophilic property of the surface of the member forming the contour of the ridges 51a and 51b. As illustrated in FIG. 5, the flat base surface 50 without the ridge 51 is considered. At this time, it is assumed that a contact angle θs between a water droplet WD and the base surface 50 is less than 90°, and the base surface 50 has a hydrophilic property. As illustrated in FIG. 6, since a plurality of the ridges 51 protruding from the base surface 50 toward the tire outer side are provided, the contact angle θs is smaller than that in the case of FIG. 5. Therefore, the surface of the member including the base surface 50 and the ridge 51 exhibits a higher hydrophilic property than the flat base surface 50.

An arithmetic mean roughness Ra of the rubber on the surfaces of the ridges 51a and 51b is preferably 0.1 μm or more and 5 μm or less. The hydrophilic property can be increased by optimizing the surface roughness. The hydrophilic property is increased by increasing the surface roughness. However, if the roughness is too large, it becomes difficult for water to enter the recess portion of the roughness, and the hydrophilic property deteriorates. The arithmetic mean roughness Ra is more preferably 0.2 μm or more and 4 μm or less. The arithmetic mean roughness Ra is measured according to JIS (Japanese Industrial Standard)-B0601.

Returning to FIG. 4, the base surface 50 is a surface recessed from a profile line 52 toward a tire cavity side. The profile line is a contour line that smoothly connects the buttress portion 32 and the bead portion 10 in the tire meridian cross-section. A profile line is composed of a single arc or a plurality of arcs. A profile line is defined excluding partial unevenness. The buttress portion 32 is a non-ground contact region of the connection portion between the profile of the tread portion 2 and the profile of the sidewall portion, and constitutes a side wall surface on the outer side of the shoulder portion 8 in the tire width direction.

As illustrated in FIG. 4, a plurality of the ridges 51a and 51b protrude from the base surface 50 toward the tire outer side. Here, a length along the contour of the ridge per cycle in the cross-sectional view along the direction orthogonal to the extension direction of the plurality of ridges 51a and 51b is defined as Lr. The length Lr is the periphery length along the contour of the ridge 51 per cycle of the plurality of ridges 51 in the cross-sectional view along the direction orthogonal to the extension direction of the plurality of ridges 51. That is, when focusing on the ridge 51a, the length Lr is the total length of a length L1 of the base surface, a length L2 of a wall surface 53, a length L3 of the top surface U, and a length L4 of the wall surface 53.

Further, a length of one cycle of the plurality of ridges 51a and 51b along the base surface 50 is defined as Lb. That is, the length Lb is the length of one pitch of the plurality of ridges 51a and 51b. A ratio Lr/Lb of the length Lr to the length Lb is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable.

The length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 4, in a cross-sectional view along a direction orthogonal to the extension direction of the ridges, an opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

Here, the top surface U of the ridges 51a and 51b and the wall surface 53 of the ridges 51a and 51b may be connected by a curved line, and the boundary between the top surface U and the wall surface 53 may not be clear. In that case, the opening width La is measured on the basis of the intersection point between a line extended from a linear portion of the top surface U of the ridge 51 and a line extended from a linear portion of the wall surface 53 of the ridge 51.

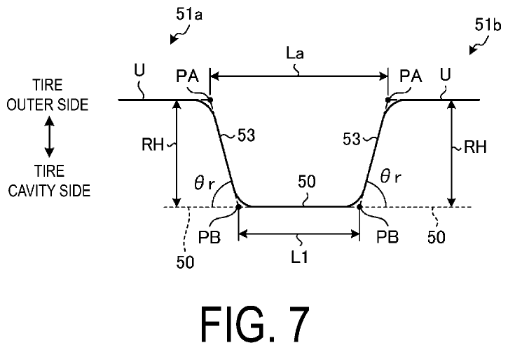

FIG. 7 is a diagram illustrating an enlarged view of a portion of FIG. 4. FIG. 7 is a diagram illustrating an enlarged view of the space between the ridge 51a and the ridge 51b in FIG. 4. FIG. 7 is a diagram illustrating an example in which the top surface U of the ridges 51a and 51b and the wall surface 53 of the ridges 51a and 51b are connected by a curved line in a cross-sectional view in a direction orthogonal to the extension direction of the ridges 51a and 51b. As illustrated in FIG. 7, when the boundary between the top surface U of the ridges 51a and 51b and the wall surface 53 is not clear, the opening width La is measured on the basis of an intersection point PA between a line extended from the linear portion of the top surface U of the ridge 51 and a line extended from the linear portion of the wall surface 53 of the ridge 51.

Returning to FIG. 4, a ratio La/Lb of the opening width La to the length Lb is preferably 0.3 or more and 0.6 or less. When the value of the ratio La/Lb is within this range, favorable results are obtained in terms of the visibility performance and the cleaning performance.

The height RH from the base surface 50 to the maximum projection position of the ridges 51a and 51b is preferably 0.08 mm or more and 0.15 mm or less. As described above, since the length Lb is preferably 0.5 mm or more and 0.7 mm or less, a ratio RH/Lb of the height RH to the length Lb is preferably 0.11 or more and 0.3 or less. When the value of the ratio RH/Lb is within this range, favorable results are obtained in terms of the visibility performance and the cleaning performance.

As illustrated in FIG. 4, the base surface 50 includes a flat portion having no unevenness. The flat portion of the base surface 50 is a straight line in a cross-sectional view along a direction orthogonal to the extension direction of the ridges 51a and 51b. Even if dirt adheres to the base surface 50, since there is a flat portion, water can enter the base surface 50 and the dirt can be washed away together with the water. The length of the straight line of the base surface 50 in the cross-sectional view is preferably 0.15 mm or more. If the length L1 of the straight line of the base surface 50 is 0.15 mm or more, favorable results are obtained in terms of the visibility performance and the cleaning performance.

Here, the base surface 50 and the wall surfaces 53 of the ridges 51a and 51b may be connected by a curved line, and the boundary between the base surface 50 and the wall surface 53 may not be clear. In that case, as illustrated in FIG. 7, the length L1 is measured on the basis of an intersection point PB between a line extended from the straight line of the base surface 50 and a line extended from the linear portion of the wall surface 53 of the ridge 51.

Returning to FIG. 4, an angle θr between the flat portion of the base surface 50 and the wall surfaces 53 of the ridges 51a and 51b is preferably 60° or more and 85° or less. When the angle θr is within this range, favorable results are obtained in terms of the visibility performance and the cleaning performance. The hydrophilic property can be enhanced by setting the angle θr appropriately. If the angle θr is larger than 85°, it becomes difficult for water to enter the base surface 50, and the hydrophilic property deteriorates. If the angle θr is smaller than 60°, the surface area does not increase and a sufficient hydrophilic property cannot be improved. The angle θr is more preferably 70° or more and 80° or less.

Here, the base surface 50 and the wall surfaces of the ridges 51a and 51b may be connected by a curved line, and the boundary between the base surface 50 and the wall surface 53 may not be clear. In that case, as illustrated in FIG. 7, the angle θr is measured on the basis of the intersection point PB between a line extended from the straight line of the base surface 50 and a line extended from the linear portion of the wall surface 53 of the ridge 51. The angle θr may be determined by measuring the angle between the line extended from the straight line of the base surface 50 and the line extended from the linear portion of the wall surface 53 of the ridge 51 and subtracting the angle from 180°.

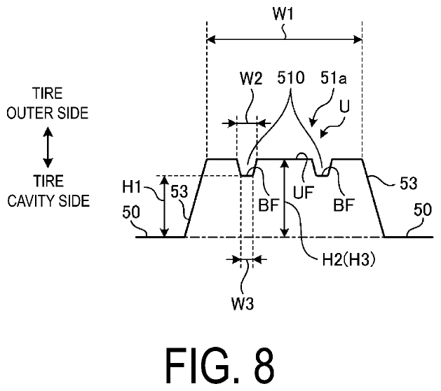

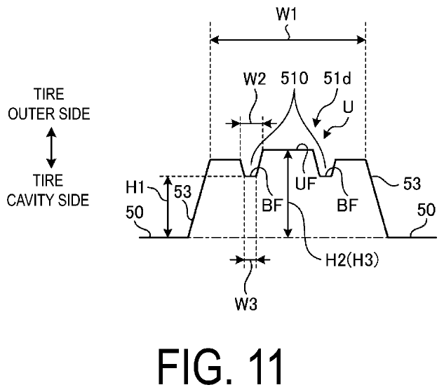

FIGS. 8 to 11 are cross-sectional diagrams illustrating another example of a ridge provided in a serration region H in FIG. 2. FIGS. 8 and 11 are cross-sectional diagrams taken along a direction orthogonal to the extension direction of the ridge. FIGS. 8 to 11 are cross-sectional diagrams illustrating an example of one set of ridges 51a, 51b, 51c, and 51d.

In FIG. 8, the ridge 51a protrudes toward the tire outer side from the base surface 50. The ridge 51a has a mountain ridge-like convex shape and extends along the tire side portion 31. The ridge 51a is substantially trapezoidal in a cross-sectional view along a direction orthogonal to the extension direction. The substantially trapezoidal shape is a shape including a flat portion having no unevenness on the upper bottom, that is, the top surface U. If at least a portion of the top surface U is a flat portion with no unevenness, it may be considered as a substantially trapezoidal shape, and the entire top surface U does not need to be a flat portion with no unevenness. When the shape of the ridge 51a is trapezoidal in a cross-sectional view along the direction orthogonal to the extension direction, the surface area of the ridge can be increased as compared with other shapes (arc, triangle) even if the height is identical, and the hydrophilic property can be improved. Further, even if it is trapezoidal, since the lower bottom coincides with the base surface 50, water can easily enter the base surface 50 as compared with the case where the upper bottom coincides with the base surface 50, and the hydrophilic property and the cleaning property can be improved.

In FIG. 8, a plurality of recess portions 510 are provided in the top surface U of the ridge 51a. In FIG. 8, in this example, two recess portions 510 are provided on the top surface U of the ridge 51a. The recess portion 510 is a portion recessed from the top surface U toward the tire cavity side. By providing the plurality of recess portions 510 on the top surface U of the ridge 51a, the surface area of the ridge can be increased, and excellent hydrophilic performance is obtained.

A bottom flat portion BF with no unevenness is provided on the bottom surface of the recess portion 510. Additionally, an inter-recess flat portion UF without unevenness is provided between two adjacent recess portions 510. Thus, two types of flat portions, that is, the bottom flat portion BF, which is a first flat portion, and the inter-recess flat portion UF, which is a second flat portion, are provided on the top surface U of the ridge 51a. Furthermore, the bottom flat portion BF and the inter-recess flat portion UF have different heights from the base surface 50, and a step is formed between both portions.

Here, a ratio H2/H1 of a height H2 from the base surface 50 to the inter-recess flat portion UF to a height H1 from the base surface 50 to the bottom flat portion BF is preferably 1.2 or more and 1.6 or less. If the ratio H2/H1 is a value within this range, a favorable hydrophilic performance and a favorable visibility performance can be obtained. If the ratio H2/H1 is less than 1.2, it is not possible to obtain a favorable hydrophilic performance and a favorable visibility performance. When the ratio H2/H1 exceeds 1.6, it is not possible to obtain a favorable hydrophilic performance and a favorable visibility performance. Note that the difference between the height H1 and the height H2 is preferably 0.03 mm or more. If the difference between the height H1 and the height H2 is 0.03 mm or more, a favorable hydrophilic performance and a favorable visibility performance can be obtained.

Additionally, a ratio W2/W1 of an opening width W2 of the top surface U of the recess portion 510 to a width W1 of the top surface U of the ridge 51a is preferably 0.1 or more and 0.3 or less, and a ratio W3/W1 of a width W3 of the recess portion 510 to the width W1 of the top surface U of the ridge 51a is preferably 0.05 or more and 0.25 or less. The same applies to the other recess portions 510 in the drawing. If the ratio W2/W1 and the ratio W3/W1 are values within these ranges, a better hydrophilic performance and a better visibility performance can be obtained.

In the ridge 51a of this example, a height H3 from the base surface 50 to the maximum height position of the top surface U of the ridge 51a is equal to the height H2. The difference between the height H1 from the base surface 50 to the bottom flat portion BF and the height H3 is preferably 0.03 mm or more and 0.15 mm or less. If the difference between the height H1 and the height H3 is within this range, a better hydrophilic performance and a better visibility performance can be obtained. If the difference between the height H1 and the height H3 is less than 0.03 mm, a favorable hydrophilic performance and a favorable visibility performance cannot be obtained. If the difference between the height H1 and the height H3 exceeds 0.15 mm, a favorable hydrophilic performance and a favorable visibility performance cannot be obtained.

A ratio (H2−H1)/(H3−H1) of a difference between the height H2 from the base surface 50 to the inter-recess flat portion UF and the height H1 from the base surface 50 to the bottom flat portion BF to a difference between the height H3 from the base surface 50 to a maximum height position of the top surface U of the ridge 51a and the height H1 from the base surface 50 to the bottom flat portion BF is preferably 0.2 or more and 0.6 or less. If the ratio (H2−H1)/(H3−H1) is a value within this range, a better hydrophilic performance and a better visibility performance can be obtained. When the ratio (H2−H1)/(H3−H1) exceeds 0.6, water does not sufficiently enter the bottom flat portion BF of the recess portion 510, and the hydrophilic performance will decline. When the ratio (H2−H1)/(H3−H1) is less than 0.2, the effect of increasing the hydrophilic performance due to the increase in surface area is small, which is not preferable. The ratio (H2−H1)/(H3−H1) is more preferably 0.3 or more and 0.5 or less.

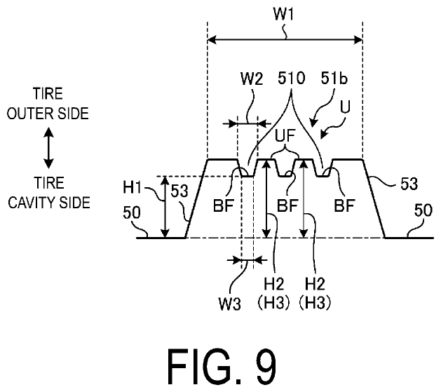

In FIG. 9, in the present example, the plurality of recess portions 510 is provided on the top surface U of the ridge 51b. In FIG. 9, in the present example, three recess portions 510 are provided on the top surface U of the ridge 51b. The other is identical to the ridge 51a described with reference to FIG. 8. In other words, for the ridge 51b illustrated in FIG. 9, the ratio H2/H1 of the height H2 to the height H1 is preferably 1.2 or more and 1.6 or less. Additionally, the ratio W2/W1 of the opening width W2 of the top surface U of the recess portion 510 to the width W1 of the top surface U of the ridge 51b is preferably 0.1 or more and 0.3 or less, and the ratio W3/W1 of the width W3 of the recess portion 510 to the width W1 of the top surface U of the ridge 51b is preferably 0.05 or more and 0.25 or less. The height H3 to the maximum height position of the top surface U of the ridge 51b is preferably equal to the height H2, and the difference between the height H1 and the height H3 is preferably 0.03 mm or more and 0.15 mm or less. The ratio (H2−H1)/(H3−H1) of the ridge 51b is preferably 0.2 or more and 0.6 or less, and more preferably 0.3 or more and 0.5 or less.

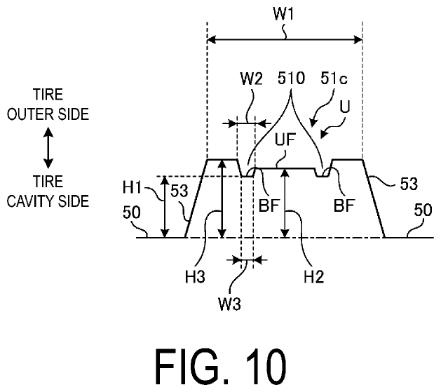

In FIG. 10, in this example, the plurality of recess portions 510 are provided on the top surface U of the ridge 51c. In FIG. 10, in this example, two recess portions 510 are provided on the top surface U of the ridge 51c. The height H2 from the base surface 50 to the inter-recess flat portion UF is different from the height H3 to the maximum height position of the top surface U of the ridge 51c. With respect to the ridge 51c illustrated in FIG. 10, the ratio H2/H1 of the height H2 to the height H1 is preferably 1.2 or more and 1.6 or less. Additionally, the ratio W2/W1 of the opening width W2 of the top surface U of the recess portion 510 to the width W1 of the top surface U of the ridge 51c is preferably 0.1 or more and 0.3 or less, and the ratio W3/W1 of the width W3 of the recess portion 510 to the width W1 of the top surface U of the ridge 51c is preferably 0.05 or more and 0.25 or less. The difference between the height H1 and the height H3 of the ridge 51c is preferably 0.03 mm or more and 0.15 mm or less. The ratio (H2−H1)/(H3−H1) of the ridge 51c is preferably 0.2 or more and 0.6 or less, and more preferably 0.3 or more and 0.5 or less.

In FIG. 11, in this example, the plurality of recess portions 510 are provided on the top surface U of the ridge 51d. In FIG. 11, in this example, two recess portions 510 are provided on the top surface U of the ridge 51d. In the ridge 51d of this example, the height H3 from the base surface 50 to the maximum height position of the top surface U of the ridge 51d is equal to the height H2. The ratio H2/H1 of the height H2 to the height H1 of the ridge 51d illustrated in FIG. 11 is preferably 1.2 or more and 1.6 or less. Additionally, the ratio W2/W1 of the opening width W2 of the top surface U of the recess portion 510 to the width W1 of the top surface U of the ridge 51d is preferably 0.1 or more and 0.3 or less, and the ratio W3/W1 of the width W3 of the recess portion 510 to the width W1 of the top surface U of the ridge 51d is preferably 0.05 or more and 0.25 or less. The difference between the height H1 and the height H3 of the ridge 51d is preferably 0.03 mm or more and 0.15 mm or less. The ratio (H2−H1)/(H3−H1) of the ridge 51d is preferably 0.2 or more and 0.6 or less, and more preferably 0.3 or more and 0.5 or less.

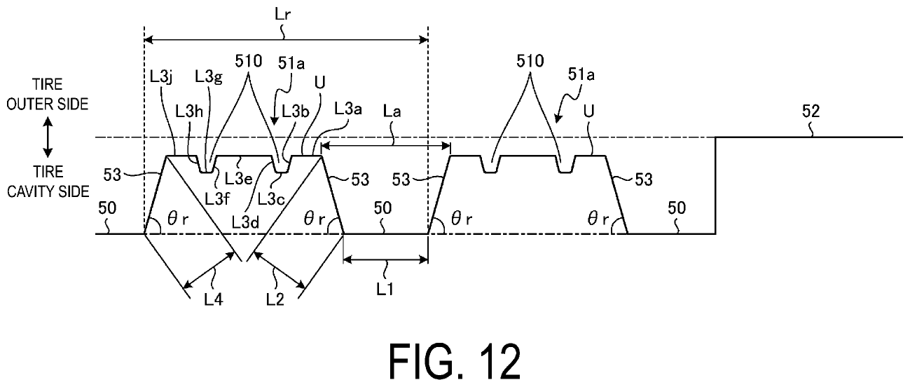

FIGS. 7 to 15 are cross-sectional diagrams illustrating an example of adjacent ridges. Returning to FIGS. 12 to 15, the base surface 50 is a surface recessed from the profile line 52 toward the tire cavity side. The profile line is a contour line that smoothly connects the buttress portion 32 and the bead portion 10 in the tire meridian cross-section. A profile line is composed of a single arc or a plurality of arcs. A profile line is defined excluding partial unevenness. The buttress portion 32 is a non-ground contact region of the connection portion between the profile of the tread portion 2 and the profile of the sidewall portion, and constitutes a side wall surface on the outer side of the shoulder portion 8 in the tire width direction.

FIG. 12 is a diagram illustrating a case in which a plurality of the ridges 51a described with reference to FIG. 8 are provided. As illustrated in FIG. 12, the plurality of ridges 51a and 51b protrude from the base surface 50 toward the tire outer side. Here, the length along the contour of the ridge per cycle in the cross-sectional view along the direction orthogonal to the extension direction of the plurality of ridges 51a is defined as Lr. The length Lr is the periphery length along the contour of the ridge 51a per cycle of the plurality of ridges 51a in the cross-sectional view along the direction orthogonal to the extension direction of the plurality of ridges 51a. That is, when focusing on one ridge 51a, the length Lr is the total length of the length L1 of the base surface, the length L2 of the wall surface 53, the lengths L3a, L3b, L3c, L3d, L3e, L3f, L3g, L3h, and L3j of respective surfaces including the recess portion 510 constituting the top surface U, and the length L4 of the wall surface 53.

Further, the length of one cycle of the plurality of ridges 51a and 51a along the base surface 50 is defined as Lb. That is, the length Lb is the length of one pitch of the plurality of ridges 51a and 51a. The ratio Lr/Lb of the length Lr to the length Lb is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable.

The length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 12, in a cross-sectional view along a direction orthogonal to the extension direction of the ridges, the opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

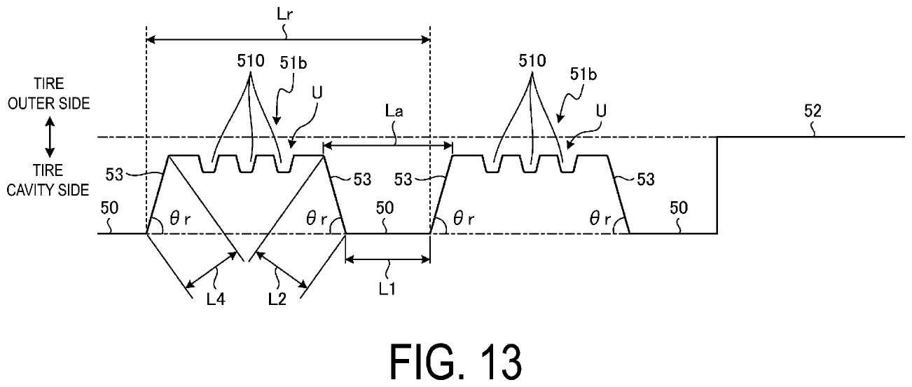

FIG. 13 is a diagram illustrating a case in which a plurality of the ridges 51b described with reference to FIG. 9 are provided. Here, the length along the contour of the ridge per cycle in the cross-sectional view along the direction orthogonal to the extension direction of the plurality of ridges 51b is defined as Lr. The length Lr is the periphery length along the contour of the ridge 51b per cycle of the plurality of ridges 51b in the cross-sectional view along the direction orthogonal to the extension direction of the plurality of ridges 51b. That is, when focusing on one ridge 51b, the length Lr is the total length of the length L1 of the base surface, the length L2 of the wall surface 53, the length of the top surface U including the respective surfaces constituting each of the recess portions 510, and the length L4 of the wall surface 53.

Similarly to the case of FIG. 12, in the case illustrated in FIG. 13, the ratio Lr/Lb of the length Lr to the length Lb of one pitch of the plurality of ridges 51b and 51b is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable.

Similarly to the case of FIG. 12, in the case illustrated in FIG. 13, the length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 13, in a cross-sectional view along a direction orthogonal to the extension direction of the ridges, the opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

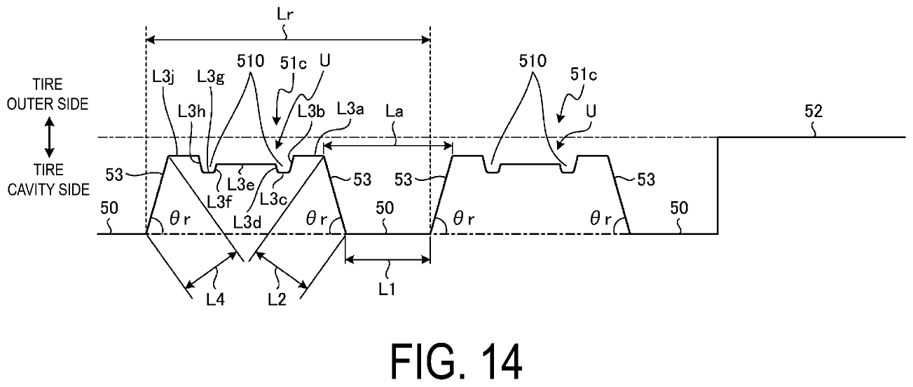

FIG. 14 is a diagram illustrating a case in which a plurality of the ridges 51c described with reference to FIG. 10 are provided. As illustrated in FIG. 14, the plurality of ridges 51c and 51c protrude from the base surface 50 toward the tire outer side. Here, the length along the contour of the ridge per cycle in the cross-sectional view along the direction orthogonal to the extension direction of the plurality of ridges 51c is defined as Lr. The length Lr is the periphery length along the contour of the ridge 51c per cycle of the plurality of ridges 51c in the cross-sectional view along the direction orthogonal to the extension direction of the plurality of ridges 51c. That is, when focusing on one ridge 51c, the length Lr is the total length of the length L1 of the base surface, the length L2 of the wall surface 53, the lengths L3a, L3b, L3c, L3d, L3e, L3f, L3g, L3h, and L3j of the respective surfaces including the recess portion 510 constituting the top surface U, and the length L4 of the wall surface 53.

Further, the length of one cycle of the plurality of ridges 51c and 51c along the base surface 50 is defined as Lb. That is, the length Lb is the length of one pitch of the plurality of ridges 51c and 51c. The ratio Lr/Lb of the length Lr to the length Lb is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable.

The length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 14, in a cross-sectional view along a direction orthogonal to the extension direction of the ridges, the opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

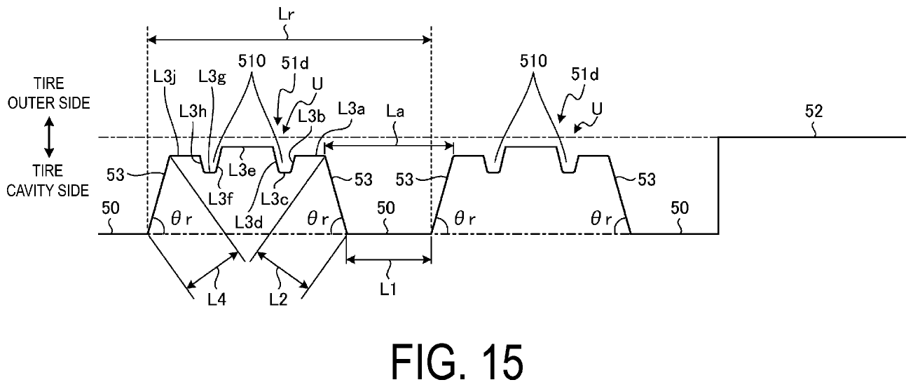

FIG. 15 is a diagram illustrating a case in which a plurality of the ridges 51d described with reference to FIG. 11 are provided. As illustrated in FIG. 15, the plurality of ridges 51d and 51d protrude from the base surface 50 toward the tire outer side. Here, the length along the contour of the ridge per cycle in the cross-sectional view along the direction orthogonal to the extension direction of the plurality of ridges 51d is defined as Lr. The length Lr is the periphery length along the contour of the ridge 51d per cycle of the plurality of ridges 51d in the cross-sectional view along the direction orthogonal to the extension direction of the plurality of ridges 51d. That is, when focusing on one ridge 51d, the length Lr is the total length of the length L1 of the base surface, the length L2 of the wall surface 53, the lengths L3a, L3b, L3c, L3d, L3e, L3f, L3g, L3h, and L3j of the respective surfaces including the recess portion 510 constituting the top surface U, and the length L4 of the wall surface 53.

Further, the length of one cycle of the plurality of ridges 51d and 51d along the base surface 50 is defined as Lb. That is, the length Lb is the length of one pitch of the plurality of ridges 51d and 51d. The ratio Lr/Lb of the length Lr to the length Lb is preferably 1.2 or more and 2.0 or less. By increasing the surface area of the ridge, the hydrophilic property of the serration region H can be improved, and the self-cleaning effect of the sidewall portion 30 when sludge is attached can be enhanced. If the ratio Lr/Lb exceeds 2.0 when the cross-sectional shape of the ridge is complex or fine, water will not enter the base surface 50 and the hydrophilic property is lowered, which is not preferable. If the ratio Lr/Lb is less than 1.2, the effect of improving the cleaning performance by the improvement in the hydrophilic property is small, which is not preferable.

The length Lb is preferably 0.5 mm or more and 0.7 mm or less. If the length Lb is less than 0.5 mm, it becomes difficult for water to enter the base surface 50 and the hydrophilic property is lowered, which is not preferable. If the length Lb exceeds 0.7 mm, the cleaning performance deteriorates, which is not preferable. If the length Lb is smaller than 0.5 mm, it becomes difficult for water to enter the base surface 50, and the hydrophilic property and the cleaning performance are deteriorated, which is not preferable.

Further, the length Lb is more preferably 0.52 mm or more, and further preferably 0.54 mm or more. When the length Lb is 0.52 mm or more, favorable results are obtained in terms of the visibility performance and the cleaning performance. Further, when the length Lb is 0.54 mm or more, more favorable results are obtained in terms of the visibility performance and the cleaning performance.

In FIG. 15, in a cross-sectional view along a direction orthogonal to the extension direction of the ridges, the opening width La between adjacent ridges is preferably 0.15 mm or more and 0.35 mm or less. When the value of the opening width is within this range, favorable results are obtained in terms of the visibility performance and the cleaning performance. The opening width La is the distance between boundary points, the boundary point between the wall surface 53 of the ridge and the top surface of the ridge in a cross-sectional view along a direction orthogonal to the extension direction of the ridge.

Here, the top surface U of the ridges and the wall surface 53 of the ridges may be connected by a curved line, and the boundary between the top surface U and the wall surface 53 may not be clear. In that case, the opening width La is measured on the basis of the intersection point between a line extended from a linear portion of the top surface U of the ridge and a line extended from a linear portion of the wall surface 53 of the ridge.

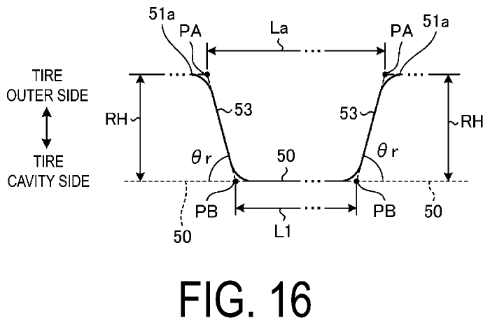

FIG. 16 is a diagram illustrating an enlarged view of a portion of FIG. 12. FIG. 16 is a diagram illustrating an enlarged view of the space between the ridge 51a and the ridge 51a in FIG. 12. FIG. 16 is a diagram illustrating an example in which the top surface U of the ridges 51a and 51a that are adjacent and the wall surface 53 of the ridges 51a and 51a are connected by a curved line in a cross-sectional view in a direction orthogonal to the extension direction of the ridges 51a and 51a. As illustrated in FIG. 16, when the boundary between the top surface U of the ridges 51a and 51a and the wall surface 53 is not clear, the opening width La is measured on the basis of the intersection point PA between a line extended from the linear portion of the top surface U of the ridge 51a and a line extended from the linear portion of the wall surface 53 of the ridge 51a. The other ridges 51b, 51c, and 51d described with reference to FIGS. 13, 14, and 15 are measured in the same manner.

Returning to FIG. 12, the ratio La/Lb of the opening width La to the length Lb is preferably 0.3 or more and 0.6 or less. When the value of the ratio La/Lb is within this range, favorable results are obtained in terms of the visibility performance and the cleaning performance.

The height RH from the base surface 50 to the maximum projection position of the ridges 51a and 51b is preferably 0.08 mm or more and 0.15 mm or less. As described above, since the length Lb is preferably 0.5 mm or more and 0.7 mm or less, a ratio RH/Lb of the height RH to the length Lb is preferably 0.11 or more and 0.3 or less. When the value of the ratio RH/Lb is within this range, favorable results are obtained in terms of the visibility performance and the cleaning performance.

As illustrated in FIG. 12, the base surface 50 includes a flat portion having no unevenness. The flat portion of the base surface 50 is a straight line in a cross-sectional view along a direction orthogonal to the extension direction of the ridges 51a and 51b. Even if dirt adheres to the base surface 50, since there is a flat portion, water can enter the base surface 50 and the dirt can be washed away together with the water. The length of the straight line of the base surface 50 in the cross-sectional view is preferably 0.15 mm or more. If the length L1 of the straight line of the base surface 50 is 0.15 mm or more, favorable results are obtained in terms of the visibility performance and the cleaning performance. The same applies to the other ridges 51b, 51c, and 51d described with reference to FIGS. 13, 14, and 15.

Here, the base surface 50 and the wall surfaces 53 of the ridges 51a and 51b may be connected by a curved line, and the boundary between the base surface 50 and the wall surface 53 may not be clear. In that case, as illustrated in FIG. 16, the length L1 is measured on the basis of the intersection point PB between a line extended from the straight line of the base surface 50 and a line extended from the linear portion of the wall surface 53 of the ridge 51. The other ridges 51b, 51c, and 51d described with reference to FIGS. 13, 14, and 15 are measured in the same manner.

Returning to FIG. 12, the angle θr between the flat portion of the base surface 50 and the wall surfaces 53 of the ridges 51a and 51b is preferably 60° or more and 85° or less. When the angle θr is within this range, favorable results are obtained in terms of the visibility performance and the cleaning performance. The hydrophilic property can be enhanced by setting the angle θr appropriately. If the angle θr is larger than 85°, it becomes difficult for water to enter the base surface 50, and the hydrophilic property deteriorates. If the angle θr is smaller than 60°, the surface area does not increase and a sufficient hydrophilic property cannot be improved. The angle θr is more preferably 70° or more and 80° or less. The same applies to the other ridges 51b, 51c, and 51d described with reference to FIGS. 13, 14, and 15.

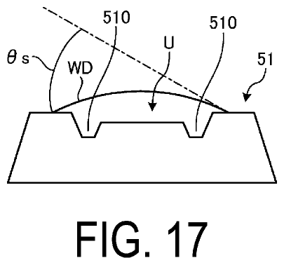

Further, the surface of the member forming the contour of the ridges 51a, 51b, 51c, and 51d described above has a hydrophilic property. By providing the ridges 51a, 51b, 51c, and 51d on the member having the hydrophilic property, the hydrophilic property can be enhanced. FIGS. 5 and 6 and 17 are diagrams for explaining the hydrophilic property of the surface of the member forming the contour of the ridges 51a, 51b, 51c, and 51d. As illustrated in FIG. 5, a flat base surface 50 without a ridge is considered. At this time, it is assumed that the contact angle θs between the water droplet WD and the base surface 50 is less than 90°, and the base surface 50 has a hydrophilic property. As illustrated in FIG. 6, since the plurality of ridges 51 protruding from the base surface 50 are provided, the contact angle θs is smaller than that in the case of FIG. 5. Therefore, the surface of the member including the base surface 50 and the ridge 51 exhibits a higher hydrophilic property than the flat base surface 50. FIG. 17 is a case when focusing on one ridge 51, and the plurality of recess portions 510 are provided on the top surface U of the ridge 51. When the plurality of recess portions 510 are provided, the contact angle θs is a smaller angle than in the case of FIG. 5. In this manner, since the plurality of ridges 51 that protrude from the base surface 50 are provided, and the plurality of recess portions 510 are provided on the top surface U of each of the ridges 51, a favorable hydrophilic performance is obtained.

The arithmetic mean roughness Ra of the rubber on the surfaces of the ridges 51a and 51b is preferably 0.1 μm or more and 5 μm or less. The hydrophilic property can be increased by optimizing the surface roughness. The hydrophilic property is increased by increasing the surface roughness. However, if the roughness is too large, it becomes difficult for water to enter the recess portion of the roughness, and the hydrophilic property deteriorates. The arithmetic mean roughness Ra is more preferably 0.2 μm or more and 4 μm or less. The arithmetic mean roughness Ra is measured according to JIS-B0601.

Here, the base surface 50 and the wall surfaces of the ridges 51a and 51b may be connected by a curved line, and the boundary between the base surface 50 and the wall surface 53 may not be clear. In that case, as illustrated in FIG. 16, the angle θr is measured on the basis of the intersection point PB between a line extended from the straight line of the base surface 50 and a line extended from the linear portion of the wall surface 53 of the ridge 51. The angle θr may be determined by measuring the angle between the line extended from the straight line of the base surface 50 and the line extended from the linear portion of the wall surface 53 of the ridge 51 and subtracting the angle from 180°. The same applies to the other ridges 51b, 51c, and 51d described with reference to FIGS. 13, 14, and 15.

### Shape and the Like of Serration Region

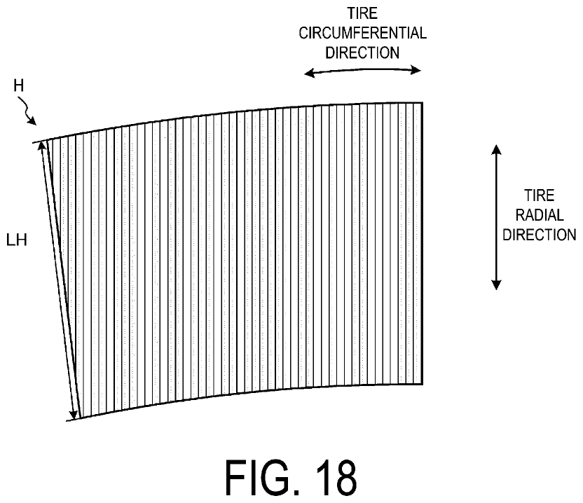

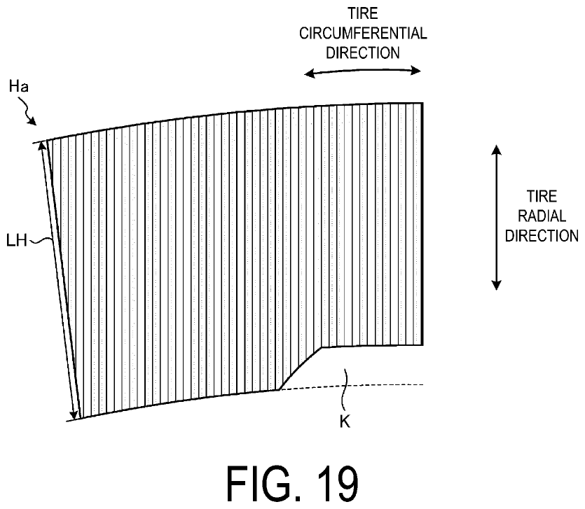

FIGS. 18 to 21 illustrate examples of the serration region H. FIGS. 18 to 21 illustrate an enlarged view of a portion of the serration region H. In the example of the serration region H illustrated in FIG. 18, the length LH of the serration region H in the tire radial direction is uniform in the tire circumferential direction. As illustrated in FIG. 19, due to the presence of a notch portion K in the serration region H, the length LH in the tire radial direction does not have to be uniform in the tire circumferential direction.

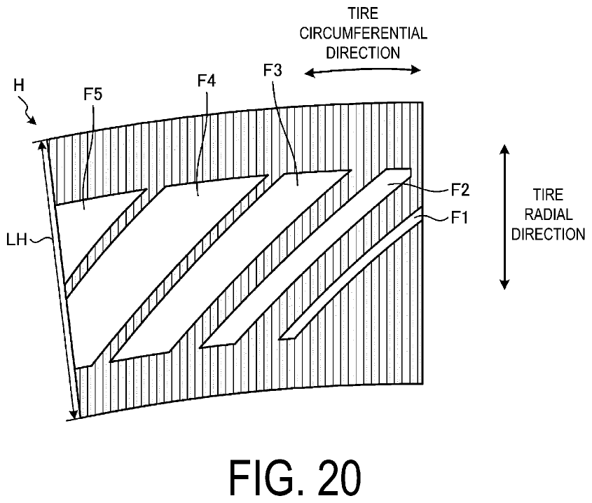

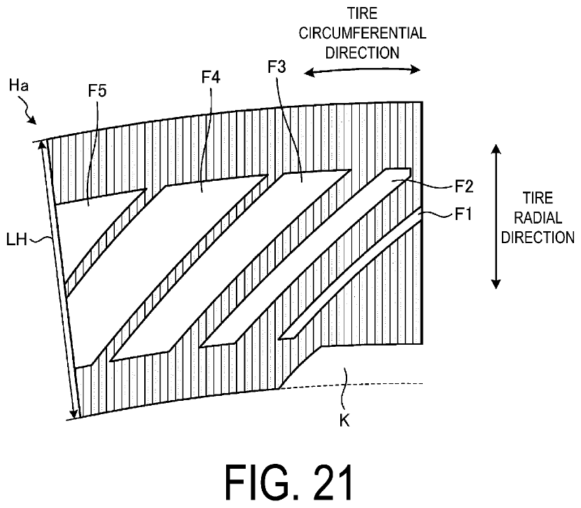

As illustrated in FIG. 20, plane portions F1, F2, F3, F4, and F5 where no ridge is provided may be provided in the serration region H. In addition, the plane portions F1 to F5 may be surfaces having an identical height to the tire profile. In addition, the plane portions F1 to F5 may be surfaces having different heights from the tire profile, and for example, surfaces having an identical height to the base surface. As illustrated in FIG. 21, the notch portion K may be formed in the serration region H, and the plane portions F1 to F5 may be provided in the serration region H.

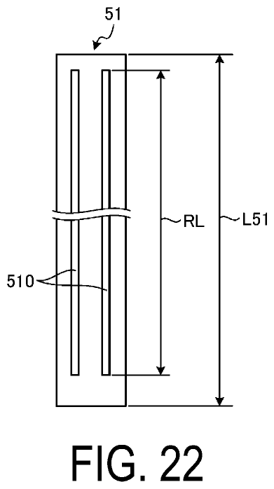

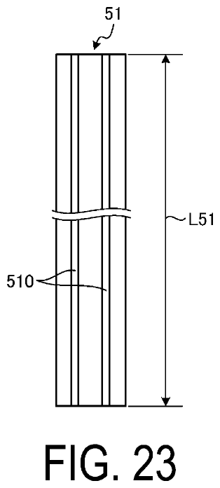

FIGS. 22 and 23 are diagrams illustrating the length of a recess portion provided in a ridge. In FIG. 22, a length of the ridge 51 along the extension direction of the ridge 51 is defined as L51. Additionally, a length of the recess portion 510 along the extension direction of the ridge 51 is defined as RL. In this case, a ratio RL/L51 of the length RL to the length L51 is preferably 0.6 or more and 1.0 or less. When the ratio RL/L51 is less than 0.6, a favorable hydrophilic performance and a favorable visibility performance cannot be obtained, which is not preferable. FIG. 23 illustrates a case where the ratio RL/L51 of lengths is 1.0. As illustrated in FIG. 23, when the recess portion 510 is provided over the entire length L51 of the ridge 51, the length RL in FIG. 22 coincides with the length L51 of the ridge 51. In this case, the ratio RL/L51 of lengths is 1.0.

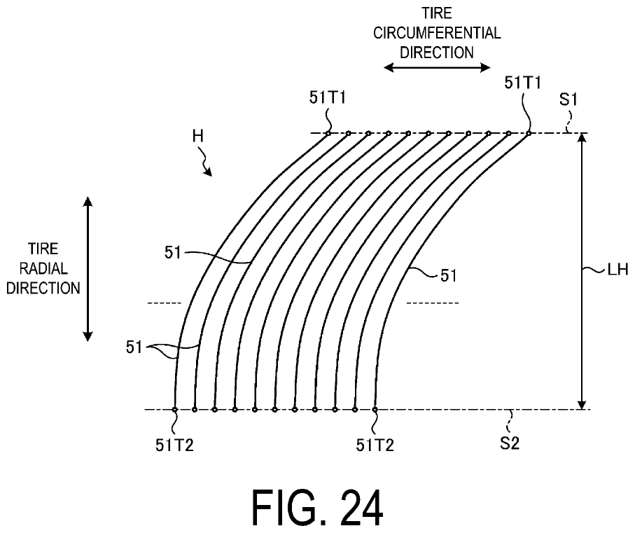

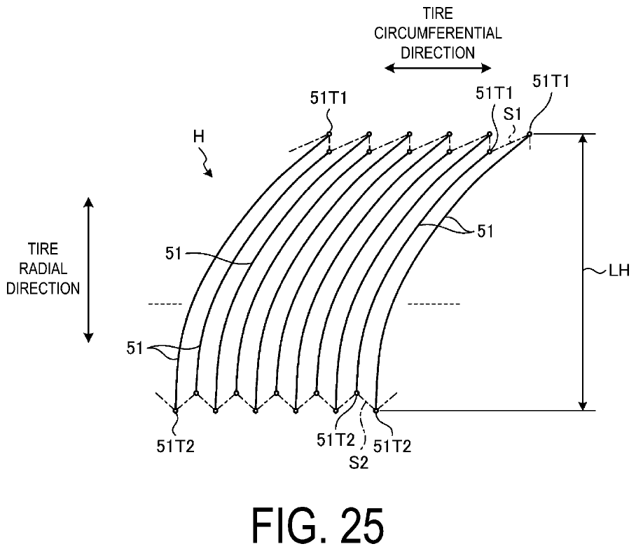

FIGS. 24 and 25 are diagrams illustrating an example of arrangement of ridges in the serration region H. In FIGS. 24 and 25, each of the plurality of ridges provided in the serration region H is indicated by a line. It is assumed that the ridges that are not drawn are provided in the tire circumferential direction in the same manner as the ridges that are clearly drawn in FIGS. 24 and 25.

As illustrated in FIG. 24, the plurality of ridges 51 are provided in the serration region H. Each of the ridges 51 is arranged in parallel with the adjacent ridges 51. Here, “parallel” means that the distance between adjacent ridges is constant in a plan view. As illustrated in FIG. 24, when the ridge includes a curved portion, “parallel” means that the distance to the adjacent ridge along the normal line of the curved portion is constant. However, even if it is not completely parallel, a difference of 10% or less with respect to the distance to the adjacent ridge is regarded as constant, that is, parallel.

In FIG. 24, the serration region H is a region between an outer imaginary line S1 connecting ends 51T1 on the outer side in the tire radial direction of each ridge 51 and an inner imaginary line S2 connecting ends 51T2 on the inner side in the tire radial direction of each ridge 51. The distance between the outer imaginary line S1 and the inner imaginary line S2 is the length LH in the tire radial direction of the serration region H.

As illustrated in FIG. 25, when the lengths of the ridges are different, a region between the outer imaginary line S1 connecting the outer ends 51T1 on the outer side in the tire radial direction and the inner imaginary line S2 connecting the ends 51T2 on the outer side in the tire radial direction of each ridge 51 is the serration region H. As illustrated in FIG. 25, when the lengths of the ridges are not the same, the distance between the outermost position in the tire radial direction of the outer imaginary line S1 and the innermost position in the tire radial direction of the inner imaginary line S2, that is, the maximum width in the tire radial direction is the length LH in the tire radial direction of the serration region H.

### Ridge Shape

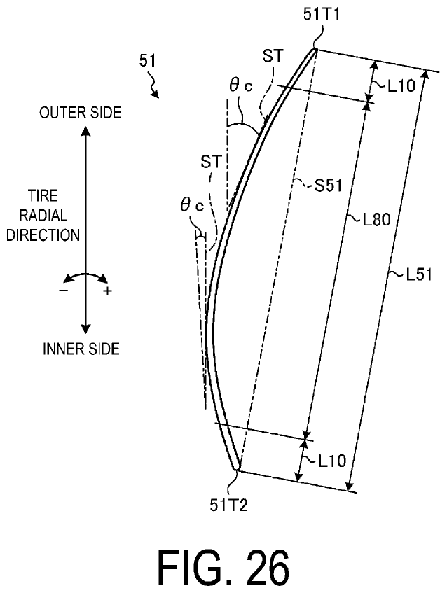

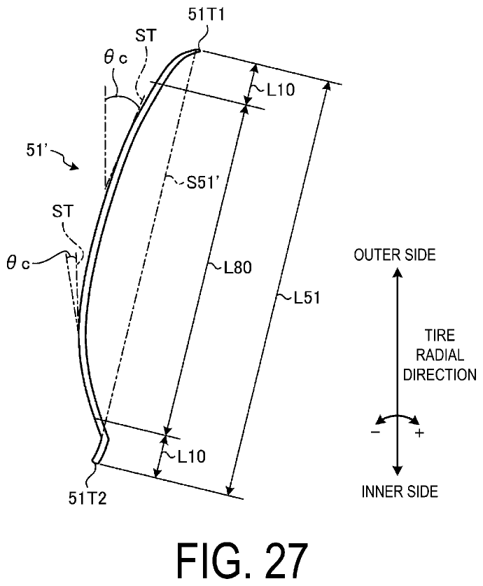

FIGS. 26 and 27 are diagrams illustrating an example of the shape of the ridge 51. FIGS. 26 and 27 are diagrams illustrating an enlarged view of one ridge 51 in the serration region.

In FIG. 26, an angle of the ridge 51 in the extension direction with respect to the tire radial direction is defined as θc. Here, regarding the angle θc, the clockwise angle is set to a plus (+) angle with respect to the direction toward the outer side in the tire radial direction, and the counterclockwise angle is set to a minus (−) angle with respect to the direction toward the outer side in the tire radial direction. As illustrated in FIG. 26, when the ridge 51 includes a curved portion, the length direction of a tangent line ST with respect to the curved portion is defined as the extension direction of the ridge 51.

The angle θc is preferably an angle within a range of ±20° with respect to the direction toward the outer side in the tire radial direction. By extending the extension direction of the ridge 51 at an angle close to the tire radial direction, the water adhering to the tire surface can be easily wetted and spread in the tire radial direction, and the deposits on the tire surface can be easily washed away. The angle θc is more preferably an angle within the range of ±10° with respect to the tire radial direction.

The angle θc does not have to be the angle within the above range over the entire length from the end 51T1 to the end 51T2 of the ridge 51. That is, with respect to an imaginary line S51 connecting the ends 51T1 and the ends 51T2 of the ridge 51 by a straight line, the angle θc may be any angle within the above range in a length L80 of 80% at the central portion of a total length L51 excluding a length L10 of 10% at both end portions.

In a ridge 51′ illustrated in FIG. 27, the curvature of the curved portion changes significantly in the vicinity of both ends. Regarding the ridge 51′ illustrated in FIG. 27, with respect to an imaginary line S51′ connecting the end 51T1 and the end 51T2 by a straight line, the angle θc may be any angle within the above range in the length L80 of 80% at the central portion of the length L51 excluding the length L10 of 10% at both end portions.

### Protrusion Portion

Returning to FIG. 1, in the tire meridian cross-sectional view, the protrusion portion B1 is located at an end portion on an outer side of the serration region H in the tire radial direction, and the protrusion portion B2 is located at an end portion on the inner side of the serration region H in the tire radial direction. The protrusion portion B1 extends in the tire circumferential direction at a position on the outer side of the serration region H in the tire radial direction. The protrusion portion B2 extends in the tire circumferential direction at a position on the inner side of the serration region H in the tire radial direction. The protrusion portion B1 and the protrusion portion B2 extend in the tire circumferential direction while connecting the ends of the ridge 51 described with reference to FIGS. 24 and 25. A recess and an air vent hole are provided in the mold to discharge air between the green tire and the mold during vulcanization molding of the tire. Therefore, the protrusion portion B1 and the protrusion portion B2 are formed at positions corresponding to the recesses of the mold. When the depth of the recesses of the mold is not uniform, the protrusion heights of the protrusion portion B1 and the protrusion portion B2 from the tire profile are not uniform. By periodically changing the protrusion heights of the protrusion portion B1 and the protrusion portion B2 from the tire profile in the tire circumferential direction, air between the green tire and the mold can be efficiently discharged during vulcanization molding of the tire.

When the pneumatic tire 1 is mounted on a regular rim and inflated to the regular internal pressure, a protrusion height BH of the protrusion portion B1 and the protrusion portion B2 from the tire profile is 0.7 mm or less. By reducing the height of the protrusion portion extending in the tire circumferential direction, the water can smoothly flow out of the tire without blocking the water flow, and the cleaning performance is not reduced. It is more preferable that the protrusion heights of the protrusion portion B1 and the protrusion portion B2 from the tire profile are 0.2 mm or more and 0.5 mm or less.

### Example A

The ridges of Example A have the cross-sectional shape described with reference to FIGS. 3 and 4. In Example A, tests for the contact angle, the cleaning performance, and the visibility performance, which are indicators of the hydrophilic property, were conducted on a plurality of types of pneumatic tires of different conditions (see Tables 1 to 4). In these tests, pneumatic tires having the size of 245/45R20 103W (20×8J) were assembled on a specified rim and inflated to a specified air pressure.

As for the contact angle, the contact angle of the obtained serration region sample with respect to water was measured by a measuring instrument. The measuring instrument used for the measurement is DM-901 available from Kyowa Interface Science Co., Ltd. The measurement was performed in accordance with JIS R3257. 2 (μl) of pure water was dropped to form water droplets, and the contact angle of the water droplets 30 seconds after the dropping was measured by the θ/2 method.

As for the cleaning performance, after mounting the pneumatic tire 1 on a 3000 cc rear-wheel drive vehicle and driving 40 km on a general road and 100 km on a highway under rainy weather conditions, the tires, completely dry, were washed for 30 seconds using a high-pressure washer (a water pressure of 100 bar and a flow rate of 300 L/h). The amount of dirt adhering to the tire side surface after washing was evaluated by sensory evaluation by three evaluators. The perfect score of 10 points was assigned to the appearance with black luster before the start of the test run. The smaller the degree of gray or white and the closer to black luster, the higher the score. Conversely, the larger the degree of gray or white, the lower the score. The evaluation was based on the average value of the total scores of the three evaluators. The score was set in 0.5 point increments, and the higher scores close to 10 points indicate better cleaning performance.

As for the visibility performance, a brand indicator was provided in the serration region, and how noticeable the brand indicator was visually evaluated. The evaluation results are calculated, with the pneumatic tire of Conventional Example 1 being assigned as 100. Larger values indicate superior visibility performance of the brand indicator.

The pneumatic tires of Examples 1 to 38 illustrated in Tables 1 to 4 include those in which the ratio Lr/Lb of the length Lr to the length Lb of one cycle of the ridge is 1.2 or more and 2.0 or less and those not, those in which the length Lb is 0.5 mm or more and 0.7 mm or less and those not, those in which the opening width La is 0.15 mm or more and 0.35 mm or less and those not, those in which the ratio La/Lb is 0.3 or more and 0.6 or less and those not, those in which the length of the straight line of the flat portion of the base surface is 0.15 mm or more and those not, those in which the ratio RH/Lb is 0.11 or more and 0.3 or less and those not, those in which the ratio LH/SH is 0.2 or more and 0.4 or less and those not, those in which the ratio AH/SH is 0.3 or more 0.5 or less and those not, those in which the angle θr is 60° or more and 85° or less and those not, those in which the angle θc is within the range of ±20° with respect to the tire radial direction and those not, those in which the arithmetic mean roughness Ra of the rubber on the surface of the ridge is 0.1 μm or more and 5 μm or less and those not, and those in which the protrusion height from the tire profile of the first protrusion portion B1 and the second protrusion portion B2 is 0.7 mm or less and those not.

In the tire of Conventional Example 1 in Table 1, the ratio Lr/Lb is 1.2, the length Lb is 1.0 mm, the opening width La is 0.13 mm, the ratio La/Lb is 0.13, the length of the straight line of the flat portion is 0.03 mm, the ratio Rh/Lb is 0.4, the ratio LH/SH is 0.15, the ratio AH/SH is 0.6, the angle θr is 55°, the angle θc is 45°, the arithmetic mean roughness Ra is 10 μm, and the height BH of the protrusion portion is 0.8 mm. In the tire of Comparative Example 1 in Table 1, the ratio Lr/Lb is 1.8, the length Lb is 0.6 mm, the opening width La is 0.13 mm, the ratio La/Lb is 0.22, the length of the straight line of the flat portion is 0.03 mm, the ratio RH/Lb is 0.3, the ratio LH/SH is 0.15, the ratio AH/SH is 0.6, the angle θr is 55°, the angle θc is 45°, the arithmetic mean roughness Ra is 10 μm, and the height BH of the protrusion portion is 0.8 mm. In the tire of Comparative Example 2 in Table 1, the ratio Lr/Lb is 1.4, the length Lb is 0.4 mm, the opening width La is 0.4 mm, the ratio La/Lb is 1.0, the length of the straight line of the flat portion is 0.3 mm, the ratio Rh/Lb is 0.4, the ratio LH/SH is 0.15, the ratio AH/SH is 0.6, the angle θr is 55°, the angle θc is 45°, the arithmetic mean roughness Ra is 10 μm, and the height BH of the protrusion portion is 0.8 mm.

Referring to Tables 1 to 4, it can be seen that favorable results are obtained when the ratio Lr/Lb of the length Lr is 1.2 or more and 2.0 or less, when the length Lb is 0.5 mm or more and 0.7 mm or less, when the opening width La is 0.15 mm or more and 0.35 mm or less, when the ratio La/Lb is 0.3 or more and 0.6 or less, when the length of the straight line of the flat portion of the base surface is 0.15 mm or more, when the ratio RH/Lb is 0.11 or more and 0.3 or less, when the ratio LH/SH is 0.2 or more and 0.4 or less, when the ratio AH/SH is 0.3 or more and 0.5 or less, when the angle θr is 60° or more and 85° or less, when the angle θc is within the range of ±20° with respect to the tire radial direction, when the arithmetic mean roughness Ra of the rubber on the surface of the ridge is 0.1 μm or more and 5 μm or less, and when the protrusion height of the first protrusion portion B1 and the second protrusion portion B2 from the tire profile is 0.7 mm or less.

TABLE 1-1

| | Conventional | Example | Comparative | Comparative |
|---|---|---|---|---|
| | Example 1 | 1 | Example 1 | Example 2 |
| Ratio Lr/Lb | 1.2 | 1.4 | 1.8 | 1.4 |
| Length Lb (mm) | 1.0 | 0.6 | 0.6 | 0.4 |
| Opening width | 0.13 | 0.13 | 0.13 | 0.4 |
| La (mm) | | | | |
| Ratio La/Lb | 0.13 | 0.22 | 0.22 | 1.0 |
| Length of flat | 0.03 | 0.03 | 0.03 | 0.3 |
| portion (mm) | | | | |
| Ratio RH/Lb | 0.4 | 0.3 | 0.3 | 0.4 |
| Ratio LH/SH | 0.15 | 0.15 | 0.15 | 0.15 |
| Ratio AH/SH | 0.6 | 0.6 | 0.6 | 0.6 |
| Angle θr (deg) | 55 | 55 | 55 | 55 |
| Angle θc (deg) | 45 | 45 | 45 | 45 |
| Surface roughness | 10 | 10 | 10 | 10 |
| Ra (μ/m) | | | | |
| Height BH of | 0.8 | 0.8 | 0.8 | 0.8 |
| protrusion | | | | |
| portion (mm) | | | | |
| Contact angle of | 80 | 70 | 80 | 80 |
| serration region | | | | |
| (deg) | | | | |
| Cleaning | 5.0 | 6.0 | 5.0 | 5.0 |
| performance | | | | |
| (score) | | | | |
| Visibility | 100 | 102 | 98 | 98 |
| (score) | | | | |

TABLE 1-2

| | Exam- | Exam- | Exam- | Exam- | Exam- | Exam- |
|---|---|---|---|---|---|---|
| | ple 2 | ple 3 | ple 4 | ple 5 | ple 6 | ple 7 |
| Ratio Lr/Lb | 1.2 | 2 | 1.5 | 1.5 | 1.6 | 1.6 |
| Length Lb | 0.5 | 0.7 | 0.5 | 0.6 | 0.6 | 0.7 |
| (mm) | | | | | | |
| Opening width | 0.13 | 0.13 | 0.13 | 0.13 | 0.13 | 0.13 |
| La (mm) | | | | | | |
| Ratio La/Lb | 0.26 | 0.19 | 0.26 | 0.22 | 0.22 | 0.19 |
| Length of flat | 0.03 | 0.03 | 0.03 | 0.03 | 0.03 | 0.03 |
| portion (mm) | | | | | | |
| Ratio RH/Lb | 0.3 | 0.2 | 0.3 | 0.3 | 0.3 | 0.2 |
| Ratio LH/SH | 0.15 | 0.15 | 0.15 | 0.15 | 0.15 | 0.15 |
| Ratio AH/SH | 0.6 | 0.6 | 0.6 | 0.6 | 0.6 | 0.6 |
| Angle θr (deg) | 55 | 55 | 55 | 55 | 55 | 55 |
| Angle θc (deg) | 45 | 45 | 45 | 45 | 45 | 45 |
| Surface | 10 | 10 | 10 | 10 | 10 | 10 |
| roughness | | | | | | |
| Ra (μ/m) | | | | | | |
| Height BH of | 0.8 | 0.8 | 0.8 | 0.8 | 0.8 | 0.8 |
| protrusion | | | | | | |
| portion (mm) | | | | | | |
| Contact angle | 75 | 75 | 70 | 65 | 65 | 70 |
| of serration | | | | | | |
| region (deg) | | | | | | |
| Cleaning | 5.5 | 5.5 | 6.0 | 6.5 | 6.5 | 6.0 |
| performance | | | | | | |
| (score) | | | | | | |
| Visibility | 101 | 101 | 102 | 103 | 103 | 102 |
| (score) | | | | | | |

TABLE 2-1

| | Exam- | Exam- | Exam- | Exam- | Exam- |
|---|---|---|---|---|---|
| | ple 8 | ple 9 | ple 10 | ple 11 | ple 12 |
| Ratio Lr/Lb | 1.7 | 1.7 | 1.5 | 1.5 | 1.5 |
| Length Lb (mm) | 0.52 | 0.54 | 0.6 | 0.6 | 0.6 |
| Opening width | 0.13 | 0.13 | 0.15 | 0.35 | 0.18 |
| La (mm) | | | | | |
| Ratio La/Lb | 0.25 | 0.24 | 0.25 | 0.58 | 0.30 |
| Length of flat | 0.03 | 0.03 | 0.05 | 0.25 | 0.08 |
| portion (mm) | | | | | |
| Ratio RH/Lb | 0.29 | 0.28 | 0.25 | 0.25 | 0.25 |
| Ratio LH/SH | 0.15 | 0.15 | 0.15 | 0.15 | 0.15 |
| Ratio AH/SH | 0.6 | 0.6 | 0.6 | 0.6 | 0.6 |
| Angle θr (deg) | 55 | 55 | 60 | 60 | 60 |
| Angle θc (deg) | 45 | 45 | 45 | 45 | 45 |
| Surface roughness | 10 | 10 | 10 | 10 | 10 |
| Ra (μ/m) | | | | | |
| Height BH of | 0.8 | 0.8 | 0.8 | 0.8 | 0.8 |
| protrusion | | | | | |
| portion (mm) | | | | | |
| Contact angle of | 74 | 75 | 62 | 62 | 60 |
| serration region | | | | | |
| (deg) | | | | | |
| Cleaning performance | 5.5 | 5.5 | 7.0 | 7.0 | 7.5 |
| (score) | | | | | |
| Visibility (score) | 101 | 101 | 104 | 104 | 105 |

TABLE 2-2

| | Exam- | Exam- | Exam- | Exam- |
|---|---|---|---|---|
| | ple 13 | ple 14 | ple 15 | ple 16 |
| Ratio Lr/Lb | 1.5 | 1.5 | 1.5 | 1.5 |
| Length Lb (mm) | 0.6 | 0.6 | 0.6 | 0.6 |
| Opening width | 0.36 | 0.25 | 0.3 | 0.3 |
| La (mm) | | | | |
| Ratio La/Lb | 0.60 | 0.42 | 0.5 | 0.5 |
| Length of flat | 0.26 | 0.15 | 0.2 | 0.2 |
| portion (mm) | | | | |
| Ratio RH/Lb | 0.25 | 0.25 | 0.11 | 0.30 |
| Ratio LH/SH | 0.15 | 0.15 | 0.15 | 0.15 |
| Ratio AH/SH | 0.6 | 0.6 | 0.6 | 0.6 |
| Angle θr (deg) | 60 | 60 | 60 | 60 |
| Angle θc (deg) | 45 | 45 | 45 | 45 |
| Surface roughness | 10 | 10 | 10 | 10 |
| Ra (μ/m) | | | | |
| Height BH of | 0.8 | 0.8 | 0.8 | 0.8 |
| protrusion portion | | | | |
| (mm) | | | | |
| Contact angle of | 62 | 58 | 60 | 60 |
| serration region | | | | |
| (deg) | | | | |
| Cleaning performance | 7.5 | 7.5 | 7.0 | 7.0 |
| (score) | | | | |
| Visibility (score) | 104 | 105 | 104 | 104 |

TABLE 3-1

| | Exam- | Exam- | Exam- | Exam- | Exam- | Exam- |
|---|---|---|---|---|---|---|
| | ple 17 | ple 18 | ple 19 | ple 20 | ple 21 | ple 22 |
| Ratio Lr/Lb | 1.5 | 1.5 | 1.5 | 1.5 | 1.5 | 1.5 |
| Length Lb | 0.6 | 0.6 | 0.6 | 0.6 | 0.6 | 0.6 |
| (mm) | | | | | | |
| Opening width | 0.3 | 0.3 | 0.3 | 0.3 | 0.3 | 0.3 |
| La (mm) | | | | | | |
| Ratio La/Lb | 0.5 | 0.5 | 0.5 | 0.5 | 0.5 | 0.5 |
| Length of flat | 0.2 | 0.2 | 0.2 | 0.2 | 0.2 | 0.2 |
| portion (mm) | | | | | | |
| Ratio RH/Lb | 0.25 | 0.25 | 0.25 | 0.25 | 0.25 | 0.25 |
| Ratio LH/SH | 0.2 | 0.4 | 0.3 | 0.3 | 0.3 | 0.3 |
| Ratio AH/SH | 0.6 | 0.6 | 0.3 | 0.5 | 0.4 | 0.4 |
| Angle θr (deg) | 60 | 60 | 60 | 60 | 80 | 85 |
| Angle θc (deg) | 45 | 45 | 45 | 45 | 45 | 45 |
| Surface | 10 | 10 | 10 | 10 | 10 | 10 |
| roughness | | | | | | |
| Ra (μ/m) | | | | | | |
| Height BH of | 0.8 | 0.8 | 0.8 | 0.8 | 0.8 | 0.8 |
| protrusion | | | | | | |
| portion (mm) | | | | | | |
| Contact angle | 58 | 58 | 58 | 58 | 55 | 57 |
| of serration | | | | | | |
| region (deg) | | | | | | |
| Cleaning | 6.5 | 7.5 | 7.0 | 7.5 | 8.0 | 7.5 |
| performance | | | | | | |
| (score) | | | | | | |
| Visibility | 105 | 104 | 105 | 104 | 106 | 106 |
| (score) | | | | | | |

TABLE 3-2

| | Exam- | Exam- | Exam- | Exam- | Exam- |
|---|---|---|---|---|---|
| | ple 23 | ple 24 | ple 25 | ple 26 | ple 27 |
| Ratio Lr/Lb | 1.55 | 1.55 | 1.55 | 1.55 | 1.55 |
| Length Lb (mm) | 0.6 | 0.6 | 0.6 | 0.6 | 0.6 |
| Opening width | 0.3 | 0.3 | 0.3 | 0.3 | 0.3 |
| La (mm) | | | | | |
| Ratio La/Lb | 0.5 | 0.5 | 0.5 | 0.5 | 0.5 |
| Length of flat | 0.2 | 0.2 | 0.2 | 0.2 | 0.2 |
| portion (mm) | | | | | |
| Ratio RH/Lb | 0.25 | 0.25 | 0.25 | 0.25 | 0.25 |
| Ratio LH/SH | 0.3 | 0.3 | 0.3 | 0.3 | 0.3 |
| Ratio AH/SH | 0.4 | 0.4 | 0.4 | 0.4 | 0.4 |
| Angle θr (deg) | 70 | 70 | 70 | 70 | 70 |
| Angle θc (deg) | 45 | 20 | 10 | −20 | −10 |
| Surface roughness | 10 | 10 | 10 | 10 | 10 |
| Ra (μ/m) | | | | | |
| Height BH of | 0.8 | 0.8 | 0.8 | 0.8 | 0.8 |
| protrusion | | | | | |
| portion (mm) | | | | | |
| Contact angle of | 55 | 55 | 55 | 55 | 55 |
| serration region | | | | | |
| (deg) | | | | | |
| Cleaning performance | 8.0 | 8.5 | 8.5 | 8.5 | 8.5 |
| (score) | | | | | |
| Visibility | 106 | 107 | 108 | 107 | 108 |
| (score) | | | | | |

TABLE 4-1

| | Exam- | Exam- | Exam- | Exam- | Exam- | Exam- |
|---|---|---|---|---|---|---|
| | ple 28 | ple 29 | ple 30 | ple 31 | ple 32 | ple 33 |
| Ratio Lr/Lb | 1.55 | 1.55 | 1.55 | 1.55 | 1.55 | 1.55 |
| Length Lb | 0.6 | 0.6 | 0.6 | 0.6 | 0.6 | 0.6 |
| (mm) | | | | | | |
| Opening width | 0.3 | 0.3 | 0.3 | 0.3 | 0.3 | 0.3 |
| La (mm) | | | | | | |
| Ratio La/Lb | 0.5 | 0.5 | 0.5 | 0.5 | 0.5 | 0.5 |
| Length of flat | 0.2 | 0.2 | 0.2 | 0.2 | 0.2 | 0.2 |
| portion (mm) | | | | | | |
| Ratio RH/Lb | 0.25 | 0.25 | 0.25 | 0.25 | 0.25 | 0.25 |
| Ratio LH/SH | 0.3 | 0.3 | 0.3 | 0.3 | 0.3 | 0.3 |
| Ratio AH/SH | 0.4 | 0.4 | 0.4 | 0.4 | 0.4 | 0.4 |
| Angle θr (deg) | 70 | 70 | 70 | 70 | 70 | 70 |
| Angle θc (deg) | 0 | 0 | 0 | 0 | 0 | 0 |
| Surface | 10 | 0.1 | 0.2 | 1 | 2 | 3 |
| roughness | | | | | | |
| Ra (μ/m) | | | | | | |
| Height BH of | 0.8 | 0.8 | 0.8 | 0.8 | 0.8 | 0.8 |
| protrusion | | | | | | |
| portion (mm) | | | | | | |
| Contact angle | 55 | 53 | 52 | 50 | 48 | 45 |
| of serration | | | | | | |
| region (deg) | | | | | | |
| Cleaning | 8.5 | 8.5 | 8.5 | 8.5 | 9.0 | 9.0 |
| performance | | | | | | |
| (score) | | | | | | |
| Visibility | 108 | 108 | 109 | 109 | 110 | 110 |
| (score) | | | | | | |

TABLE 4-2

| | Exam- | Exam- | Exam- | Exam- | Exam- |
|---|---|---|---|---|---|
| | ple 34 | ple 35 | ple 36 | ple 37 | ple 38 |
| Ratio Lr/Lb | 1.55 | 1.55 | 1.55 | 1.55 | 1.55 |
| Length Lb (mm) | 0.6 | 0.6 | 0.6 | 0.6 | 0.6 |
| Opening width | 0.3 | 0.3 | 0.3 | 0.3 | 0.3 |
| La (mm) | | | | | |
| Ratio La/Lb | 0.5 | 0.5 | 0.5 | 0.5 | 0.5 |
| Length of flat | 0.2 | 0.2 | 0.2 | 0.2 | 0.2 |
| portion (mm) | | | | | |
| Ratio RH/Lb | 0.25 | 0.25 | 0.25 | 0.25 | 0.25 |
| Ratio LH/SH | 0.3 | 0.3 | 0.3 | 0.3 | 0.3 |
| Ratio AH/SH | 0.4 | 0.4 | 0.4 | 0.4 | 0.4 |
| Angle θr (deg) | 70 | 70 | 70 | 70 | 70 |
| Angle θc (deg) | 0 | 0 | 0 | 0 | 0 |
| Surface roughness | 4 | 5 | 3 | 3 | 1 |
| Ra (μ/m) | | | | | |
| Height BH of | 0.8 | 0.8 | 0.2 | 0.5 | 0.15 |
| protrusion | | | | | |
| portion (mm) | | | | | |
| Contact angle of | 50 | 53 | 45 | 45 | 45 |
| serration region | | | | | |
| (deg) | | | | | |
| Cleaning performance | 9.0 | 8.5 | 9.5 | 9.5 | 9.5 |
| (score) | | | | | |
| Visibility (score) | 109 | 108 | 112 | 111 | 112 |

### Example B

The ridges of Example B have a cross-sectional shape as described with reference to FIGS. 8 to 15. In Example B, tests for the contact angle, the cleaning performance, and the visibility performance, which are indicators of the hydrophilic property, were conducted on a plurality of types of pneumatic tires of different conditions (see Tables 5 to 10). In these tests, pneumatic tires having the size of 245/45R20 103W (20×8J) were assembled on a specified rim and inflated to a specified air pressure.

As for the contact angle, the contact angle of the obtained serration region sample with respect to water was measured by a measuring instrument. The measuring instrument used for the measurement is DM-901 available from Kyowa Interface Science Co., Ltd. The measurement was performed in accordance with JIS R3257. 2 (μl) of pure water was dropped to form water droplets, and the contact angle of the water droplets 30 seconds after the dropping was measured by the 0/2 method.

As for the cleaning performance, after mounting the pneumatic tire 1 on a 3000 cc rear-wheel drive vehicle and driving 40 km on a general road and 100 km on a highway under rainy weather conditions, the tires, completely dry, were washed for 30 seconds using a high-pressure washer (a water pressure of 100 bar and a flow rate of 300 L/h). The amount of dirt adhering to the tire side surface after washing was evaluated by sensory evaluation by three evaluators. The perfect score of 10 points was assigned to the appearance with black luster before the start of the test run. The smaller the degree of gray or white and the closer to black luster, the higher the score. Conversely, the larger the degree of gray or white, the lower the score. The evaluation was based on the average value of the total scores of the three evaluators. The score was set in 0.5 point increments, and the higher scores close to 10 points indicate better cleaning performance.

As for the visibility performance, a brand indicator was provided in the serration region, and how noticeable the brand indicator was visually evaluated. The evaluation results are calculated, with the pneumatic tire of Conventional Example 2 being assigned as 100. Larger values indicate superior visibility performance of the brand indicator.

The pneumatic tires of Examples 39 to 89 illustrated in Tables 5 to 10 include those in which the length Lb of one cycle of the ridge is 0.5 mm or more and 0.7 mm or less and those not, those in which the height ratio H2/H1 is 1.2 or more and 1.6 or less and those not, those in which the ratio Lr/Lb of the length Lr to the length Lb is 1.2 or more and 2.0 or less and those not, those in which the ratio W2/W1 is 0.1 or more and 0.3 or less and those not, those in which the ratio W3/W1 is 0.05 or more and 0.25 or less and those not, those in which the difference between the height H1 and the height H3 is 0.03 mm or more and 0.15 mm or less and those not, those in which the ratio (H2−H1)/(H3-H1) is 0.2 or more and 0.6 or less and those not, those in which the length of the straight line of the flat portion of the base surface is 0.15 mm or more and those not, those in which the ratio RH/Lb is 0.11 or more and 0.3 or less and those not, those in which the ratio LH/SH is 0.2 or more and 0.4 or less and those not, those in which the ratio AH/SH is 0.3 or more and 0.5 or less and those not, those in which the angle θr is 60° or more and 85° or less and those not, those in which the angle θc is within the range of ±20° with respect to the tire radial direction and those not, those in which the arithmetic mean roughness Ra of the rubber on the surface of the ridge is 0.1 μm or more and 5 μm or less and those not, and those in which the protrusion height from the tire profile of the first protrusion portion B1 and the second protrusion portion B2 is 0.7 mm or less and those not.

In the tire of Conventional Example 2 in Table 5, the length Lb is 1.0 mm, the height ratio H2/H1 is 1.5, the ratio Lr/Lb is 1.2, the ratio W2/W1 is 0.33, the ratio W3/W1 is 0.27, the difference between the height H1 and the height H3 is 0.05 mm, the ratio (H2−H1)/(H3−H1) is 1.0, the length of the straight line of the flat portion of the base surface is 0.08 mm, the ratio Rh/Lb is 0.30, the ratio LH/SH is 0.15, the ratio AH/SH is 0.6, the angle θr is 55°, the angle θc is 45°, the arithmetic mean roughness Ra is 10 μm, and the height BH of the protrusion portion is 0.8 mm.

Referring to Tables 5 to 10, it can be seen that favorable results are obtained when the length Lb is 0.5 mm or more and 0.7 mm or less, when the height ratio H2/H1 is 1.2 or more and 1.6 or less, when the ratio Lr/Lb is 1.2 or more and 2.0 or less, when the ratio W2/W1 is 0.1 or more and 0.3 or less, when the ratio W3/W1 is 0.05 or more and 0.25 or less, when the difference between the height H1 and the height H3 is 0.03 mm or more and 0.15 mm or less, when the ratio (H2−H1)/(H3−H1) is 0.2 or more and 0.6 or less, when the length of the straight line of the flat portion of the base surface is 0.15 mm or more, when the ratio RH/Lb is 0.11 or more and 0.3 or less, when the ratio LH/SH is 0.2 or more and 0.4 or less, when the ratio AH/SH is 0.3 or more and 0.5 or less, when the angle θr is 60° or more and 85° or less, when the angle θc is within the range of ±20° with respect to the tire radial direction, when the arithmetic mean roughness Ra of the rubber on the surface of the ridge is 0.1 μm or more and 5 μm or less, and when the protrusion height of the first protrusion portion B1 and the second protrusion portion B2 from the tire profile is 0.7 mm or less.

TABLE 5-1

| | Conven- | | | |
|---|---|---|---|---|
| | tional | Exam- | Exam- | Exam- |
| | Example 2 | ple 39 | ple 40 | ple 41 |
| Length Lb (mm) | 0.5 | 0.6 | 0.5 | 0.52 |
| Height ratio H2/H1 | 1.5 | 1.5 | 1.5 | 1.5 |
| Ratio Lr/Lb | 1.2 | 1.6 | 1.4 | 1.4 |
| Ratio W2/W1 | 0.33 | 0.33 | 0.33 | 0.33 |
| Ratio W3/W1 | 0.27 | 0.27 | 0.27 | 0.27 |
| Difference between | 0.05 | 0.05 | 0.05 | 0.05 |
| H1 and H3 (mm) | | | | |
| Ratio (H2 − H1)/ | 1.0 | 1.0 | 1.0 | 1.0 |
| (H3 − H1) | | | | |
| Length of flat | 0.08 | 0.08 | 0.08 | 0.08 |
| portion (mm) | | | | |
| Ratio RH/Lb | 0.30 | 0.25 | 0.30 | 0.29 |
| Ratio LH/SH | 0.15 | 0.15 | 0.15 | 0.15 |
| Ratio AH/SH | 0.6 | 0.6 | 0.6 | 0.6 |
| Angle θr (deg) | 55 | 55 | 55 | 55 |
| Angle θc (deg) | 45 | 45 | 45 | 45 |
| Ridge surface roughness | 10 | 10 | 10 | 10 |
| Ra (μ/m) | | | | |
| Protrusion height of | 0.8 | 0.8 | 0.8 | 0.8 |
| protrusion portions (mm) | | | | |
| Contact angle of | 80 | 75 | 77 | 76 |
| serration region | | | | |
| (deg) | | | | |
| Cleaning performance | 5 | 6.5 | 6 | 6 |
| (score) | | | | |
| Visibility performance | 100 | 103 | 101 | 102 |
| (score) | | | | |

TABLE 5-2

| | Exam- | Exam- | Exam- | Exam- | Exam- |
|---|---|---|---|---|---|
| | ple 42 | ple 43 | ple 44 | ple 45 | ple 46 |
| Length Lb (mm) | 0.54 | 0.7 | 0.6 | 0.6 | 0.6 |
| Height ratio H2/H1 | 1.5 | 1.5 | 1.2 | 1.6 | 1.5 |
| Ratio Lr/Lb | 1.4 | 1.4 | 1.4 | 1.4 | 1.2 |
| Ratio W2/W1 | 0.33 | 0.33 | 0.33 | 0.33 | 0.33 |
| Ratio W3/W1 | 0.27 | 0.27 | 0.27 | 0.27 | 0.27 |
| Difference between | 0.05 | 0.05 | 0.05 | 0.05 | 0.05 |
| H1 and H3 (mm) | | | | | |
| Ratio (H2 − H1)/ | 1.0 | 1.0 | 1.0 | 1.0 | 1.0 |
| (H3 − H1) | | | | | |
| Length of flat | 0.08 | 0.08 | 0.08 | 0.08 | 0.08 |
| portion (mm) | | | | | |
| Ratio RH/Lb | 0.28 | 0.21 | 0.25 | 0.25 | 0.25 |
| Ratio LH/SH | 0.15 | 0.15 | 0.15 | 0.15 | 0.15 |
| Ratio AH/SH | 0.6 | 0.6 | 0.6 | 0.6 | 0.6 |
| Angle θr (deg) | 55 | 55 | 55 | 55 | 55 |
| Angle θc (deg) | 45 | 45 | 45 | 45 | 45 |
| Ridge surface roughness | 10 | 10 | 10 | 10 | 10 |
| Ra (μ/m) | | | | | |
| Protrusion height of | 0.8 | 0.8 | 0.8 | 0.8 | 0.8 |
| protrusion portions (mm) | | | | | |
| Contact angle of | 75 | 76 | 78 | 74 | 77 |
| serration region | | | | | |
| (deg) | | | | | |
| Cleaning performance | 6.5 | 6.5 | 6.5 | 6.5 | 6.5 |
| (score) | | | | | |
| Visibility performance | 103 | 103 | 103 | 103 | 103 |
| (score) | | | | | |

TABLE 6-1

| | Exam- | Exam- | Exam- | Exam- | Exam- |
|---|---|---|---|---|---|
| | ple 47 | ple 48 | ple 49 | ple 50 | ple 51 |
| Length Lb (mm) | 0.6 | 0.6 | 0.6 | 0.6 | 0.6 |
| Height ratio H2/H1 | 1.5 | 1.5 | 1.5 | 1.5 | 1.5 |
| Ratio Lr/Lb | 2.0 | 1.65 | 1.65 | 1.65 | 1.65 |
| Ratio W2/W1 | 0.33 | 0.33 | 0.10 | 0.30 | 0.17 |
| Ratio W3/W1 | 0.27 | 0.27 | 0.27 | 0.27 | 0.27 |
| Difference between | 0.05 | 0.05 | 0.05 | 0.05 | 0.05 |
| H1 and H3 (mm) | | | | | |
| Ratio (H2 − H1)/ | 1.0 | 1.0 | 1.0 | 1.0 | 1.0 |
| (H3 − H1) | | | | | |
| Length of flat | 0.08 | 0.08 | 0.08 | 0.08 | 0.08 |
| portion (mm) | | | | | |
| Ratio RH/Lb | 0.25 | 0.25 | 0.25 | 0.25 | 0.25 |
| Ratio LH/SH | 0.15 | 0.15 | 0.15 | 0.15 | 0.15 |
| Ratio AH/SH | 0.6 | 0.6 | 0.6 | 0.6 | 0.6 |
| Angle θr (deg) | 55 | 55 | 55 | 55 | 55 |
| Angle θc (deg) | 45 | 45 | 45 | 45 | 45 |
| Ridge surface roughness | 10 | 10 | 10 | 10 | 10 |
| Ra (μ/m) | | | | | |
| Protrusion height of | 0.8 | 0.8 | 0.8 | 0.8 | 0.8 |
| protrusion portions (mm) | | | | | |
| Contact angle of | 77 | 74 | 72 | 70 | 68 |
| serration region | | | | | |
| (deg) | | | | | |
| Cleaning performance | 6.5 | 6.5 | 7 | 7 | 7 |
| (score) | | | | | |
| Visibility performance | 103 | 103 | 104 | 104 | 105 |
| (score) | | | | | |

TABLE 6-2

| | Exam- | Exam- | Exam- | Exam- |
|---|---|---|---|---|
| | ple 52 | ple 53 | ple 54 | ple 55 |
| Length Lb (mm) | 0.6 | 0.6 | 0.6 | 0.6 |
| Height ratio H2/H1 | 1.5 | 1.5 | 1.3 | 2.5 |
| Ratio Lr/Lb | 1.65 | 1.65 | 1.65 | 1.65 |
| Ratio W2/W1 | 0.17 | 0.17 | 0.17 | 0.17 |
| Ratio W3/W1 | 0.05 | 0.25 | 0.13 | 0.13 |
| Difference between | 0.05 | 0.05 | 0.03 | 0.15 |
| H1 and H3 (mm) | | | | |
| Ratio (H2 − H1)/ | 1.0 | 1.0 | 1.0 | 1.0 |
| (H3 − H1) | | | | |
| Length of flat | 0.08 | 0.08 | 0.08 | 0.08 |
| portion (mm) | | | | |
| Ratio RH/Lb | 0.25 | 0.25 | 0.22 | 0.42 |
| Ratio LH/SH | 0.15 | 0.15 | 0.15 | 0.15 |
| Ratio AH/SH | 0.6 | 0.6 | 0.6 | 0.6 |
| Angle θr (deg) | 55 | 55 | 55 | 55 |
| Angle θc (deg) | 45 | 45 | 45 | 45 |
| Ridge surface roughness | 10 | 10 | 10 | 10 |
| Ra (μ/m) | | | | |
| Protrusion height of | 0.8 | 0.8 | 0.8 | 0.8 |
| protrusion portions (mm) | | | | |
| Contact angle of | 67 | 67 | 68 | 68 |
| serration region (deg) | | | | |
| Cleaning performance | 7 | 7 | 7 | 7 |
| (score) | | | | |
| Visibility performance | 106 | 106 | 105 | 105 |
| (score) | | | | |

TABLE 7-1

| | Exam- | Exam- | Exam- | Exam- | Exam- |
|---|---|---|---|---|---|
| | ple 56 | ple 57 | ple 58 | ple 59 | ple 60 |
| Length Lb (mm) | 0.6 | 0.6 | 0.6 | 0.6 | 0.6 |
| Height ratio H2/H1 | 1.2 | 1.3 | 1.5 | 1.6 | 1.4 |
| Ratio Lr/Lb | 1.65 | 1.65 | 1.65 | 1.65 | 1.65 |
| Ratio W2/W1 | 0.17 | 0.17 | 0.17 | 0.17 | 0.17 |
| Ratio W3/W1 | 0.13 | 0.13 | 0.13 | 0.13 | 0.13 |
| Difference between | 0.1 | 0.1 | 0.1 | 0.1 | 0.1 |
| H1 and H3 (mm) | | | | | |
| Ratio (H2 − H1)/ | 0.2 | 0.3 | 0.5 | 0.6 | 0.4 |
| (H3 − H1) | | | | | |
| Length of flat | 0.08 | 0.08 | 0.08 | 0.08 | 0.15 |
| portion (mm) | | | | | |
| Ratio RH/Lb | 0.33 | 0.33 | 0.33 | 0.33 | 0.33 |
| Ratio LH/SH | 0.15 | 0.15 | 0.15 | 0.15 | 0.15 |
| Ratio AH/SH | 0.6 | 0.6 | 0.6 | 0.6 | 0.6 |
| Angle θr (deg) | 55 | 55 | 55 | 55 | 55 |
| Angle θc (deg) | 45 | 45 | 45 | 45 | 45 |
| Ridge surface roughness | 10 | 10 | 10 | 10 | 10 |
| Ra (μ/m) | | | | | |
| Protrusion height of | 0.8 | 0.8 | 0.8 | 0.8 | 0.8 |
| protrusion portions (mm) | | | | | |
| Contact angle of | 68 | 67 | 67 | 68 | 66 |
| serration region | | | | | |
| (deg) | | | | | |
| Cleaning performance | 7 | 7.5 | 7.5 | 7 | 7.5 |
| (score) | | | | | |
| Visibility performance | 105 | 106 | 106 | 105 | 107 |
| (score) | | | | | |

TABLE 7-2

| | Exam- | Exam- | Exam- | Exam- |
|---|---|---|---|---|
| | ple 61 | ple 62 | ple 63 | ple 64 |
| Length Lb (mm) | 0.7 | 0.6 | 0.6 | 0.6 |
| Height ratio H2/H1 | 1.2 | 1.4 | 1.3 | 1.3 |
| Ratio Lr/Lb | 1.65 | 1.65 | 1.65 | 1.65 |
| Ratio W2/W1 | 0.17 | 0.17 | 0.17 | 0.17 |
| Ratio W3/W1 | 0.13 | 0.13 | 0.13 | 0.13 |
| Difference between | 0.03 | 0.08 | 0.06 | 0.06 |
| H1 and H3 (mm) | | | | |
| Ratio (H2 − H1)/ | 0.3 | 0.5 | 0.5 | 0.5 |
| (H3 − H1) | | | | |
| Length of flat | 0.15 | 0.15 | 0.15 | 0.15 |
| portion (mm) | | | | |
| Ratio RH/Lb | 0.11 | 0.30 | 0.27 | 0.27 |
| Ratio LH/SH | 0.15 | 0.15 | 0.2 | 0.4 |
| Ratio AH/SH | 0.6 | 0.6 | 0.6 | 0.6 |
| Angle θr (deg) | 55 | 55 | 55 | 55 |
| Angle θc (deg) | 45 | 45 | 45 | 45 |
| Ridge surface roughness | 10 | 10 | 10 | 10 |
| Ra (μ/m) | | | | |
| Protrusion height of | 0.8 | 0.8 | 0.8 | 0.8 |
| protrusion portions (mm) | | | | |
| Contact angle of serration | 65 | 65 | 65 | 65 |
| region (deg) | | | | |
| Cleaning performance | 7.5 | 7.5 | 7.5 | 7.5 |
| (score) | | | | |
| Visibility performance | 107 | 107 | 108 | 108 |
| (score) | | | | |

TABLE 8-1

| | Exam- | Exam- | Exam- | Exam- | Exam- |
|---|---|---|---|---|---|
| | ple 65 | ple 66 | ple 67 | ple 68 | ple 69 |
| Length Lb (mm) | 0.6 | 0.6 | 0.6 | 0.6 | 0.6 |
| Height ratio H2/H1 | 1.3 | 1.3 | 1.3 | 1.3 | 1.3 |
| Ratio Lr/Lb | 1.65 | 1.65 | 1.65 | 1.65 | 1.65 |
| Ratio W2/W1 | 0.17 | 0.17 | 0.17 | 0.17 | 0.17 |
| Ratio W3/W1 | 0.13 | 0.13 | 0.13 | 0.13 | 0.13 |
| Difference between | 0.06 | 0.06 | 0.06 | 0.06 | 0.06 |
| H1 and H3 (mm) | | | | | |
| Ratio (H2 − H1)/ | 0.5 | 0.5 | 0.5 | 0.5 | 0.5 |
| (H3 − H1) | | | | | |
| Length of flat | 0.15 | 0.15 | 0.15 | 0.15 | 0.15 |
| portion (mm) | | | | | |
| Ratio RH/Lb | 0.27 | 0.27 | 0.27 | 0.27 | 0.27 |
| Ratio LH/SH | 0.3 | 0.3 | 0.3 | 0.3 | 0.3 |
| Ratio AH/SH | 0.3 | 0.5 | 0.4 | 0.4 | 0.4 |
| Angle θr (deg) | 55 | 55 | 50 | 60 | 70 |
| Angle θc (deg) | 45 | 45 | 45 | 45 | 45 |
| Ridge surface roughness | 10 | 10 | 10 | 10 | 10 |
| Ra (μ/m) | | | | | |
| Protrusion height of | 0.8 | 0.8 | 0.8 | 0.8 | 0.8 |
| protrusion portions (mm) | | | | | |
| Contact angle of | 65 | 65 | 66 | 64 | 63 |
| serration region | | | | | |
| (deg) | | | | | |
| Cleaning performance | 7.5 | 7.5 | 7.5 | 7.5 | 8 |
| (score) | | | | | |
| Visibility performance | 109 | 109 | 108 | 110 | 111 |
| (score) | | | | | |

TABLE 8-2

| | Exam- | Exam- | Exam- | Exam- |
|---|---|---|---|---|
| | ple 70 | ple 71 | ple 72 | ple 73 |
| Length Lb (mm) | 0.6 | 0.6 | 0.6 | 0.6 |
| Height ratio H2/H1 | 1.3 | 1.3 | 1.3 | 1.3 |
| Ratio Lr/Lb | 1.65 | 1.65 | 1.65 | 1.65 |
| Ratio W2/W1 | 0.17 | 0.17 | 0.17 | 0.17 |
| Ratio W3/W1 | 0.13 | 0.13 | 0.13 | 0.13 |
| Difference between | 0.06 | 0.06 | 0.06 | 0.06 |
| H1 and H3 (mm) | | | | |
| Ratio (H2 − H1)/ | 0.5 | 0.5 | 0.5 | 0.5 |
| (H3 − H1) | | | | |
| Length of flat | 0.15 | 0.15 | 0.15 | 0.15 |
| portion (mm) | | | | |
| Ratio RH/Lb | 0.27 | 0.27 | 0.27 | 0.27 |
| Ratio LH/SH | 0.3 | 0.3 | 0.3 | 0.3 |
| Ratio AH/SH | 0.4 | 0.4 | 0.4 | 0.4 |
| Angle θr (deg) | 80 | 85 | 70 | 70 |
| Angle θc (deg) | 45 | 45 | 10 | 20 |
| Ridge surface roughness | 10 | 10 | 10 | 10 |
| Ra (μ/m) | | | | |
| Protrusion height of | 0.8 | 0.8 | 0.8 | 0.8 |
| protrusion portions (mm) | | | | |
| Contact angle of serration | 63 | 64 | 64 | 64 |
| region (deg) | | | | |
| Cleaning performance | 8 | 7.5 | 8 | 8 |
| (score) | | | | |
| Visibility performance | 111 | 110 | 112 | 111 |
| (score) | | | | |

TABLE 9-1

| | Exam- | Exam- | Exam- | Exam- | Exam- |
|---|---|---|---|---|---|
| | ple 74 | ple 75 | ple 76 | ple 77 | ple 78 |
| Length Lb (mm) | 0.6 | 0.6 | 0.6 | 0.6 | 0.6 |
| Height ratio H2/H1 | 1.3 | 1.3 | 1.3 | 1.3 | 1.3 |
| Ratio Lr/Lb | 1.65 | 1.65 | 1.65 | 1.65 | 1.65 |
| Ratio W2/W1 | 0.17 | 0.17 | 0.17 | 0.17 | 0.17 |
| Ratio W3/W1 | 0.13 | 0.13 | 0.13 | 0.13 | 0.13 |
| Difference between | 0.06 | 0.06 | 0.06 | 0.06 | 0.06 |
| H1 and H3 (mm) | | | | | |
| Ratio (H2 − H1)/ | 0.5 | 0.5 | 0.5 | 0.5 | 0.5 |
| (H3 − H1) | | | | | |
| Length of flat | 0.15 | 0.15 | 0.15 | 0.15 | 0.15 |
| portion (mm) | | | | | |
| Ratio RH/Lb | 0.27 | 0.27 | 0.27 | 0.27 | 0.27 |
| Ratio LH/SH | 0.3 | 0.3 | 0.3 | 0.3 | 0.3 |
| Ratio AH/SH | 0.4 | 0.4 | 0.4 | 0.4 | 0.4 |
| Angle θr (deg) | 70 | 70 | 70 | 70 | 70 |
| Angle θc (deg) | 30 | 45 | −10 | −20 | 0 |
| Ridge surface roughness | 10 | 10 | 10 | 10 | 0.1 |
| Ra (μ/m) | | | | | |
| Protrusion height of | 0.8 | 0.8 | 0.8 | 0.8 | 0.8 |
| protrusion portions (mm) | | | | | |
| Contact angle of | 64 | 64 | 64 | 64 | 63 |
| serration region | | | | | |
| (deg) | | | | | |
| Cleaning performance | 7.5 | 7.5 | 8 | 8 | 8 |
| (score) | | | | | |
| Visibility performance | 110 | 108 | 112 | 111 | 112 |
| (score) | | | | | |

TABLE 9-2

| | Exam- | Exam- | Exam- | Exam- |
|---|---|---|---|---|
| | ple 79 | ple 80 | ple 81 | ple 82 |
| Length Lb (mm) | 0.6 | 0.6 | 0.6 | 0.6 |
| Height ratio H2/H1 | 1.3 | 1.3 | 1.3 | 1.3 |
| Ratio Lr/Lb | 1.65 | 1.65 | 1.65 | 1.65 |
| Ratio W2/W1 | 0.17 | 0.17 | 0.17 | 0.17 |
| Ratio W3/W1 | 0.13 | 0.13 | 0.13 | 0.13 |
| Difference between | 0.06 | 0.06 | 0.06 | 0.06 |
| H1 and H3 (mm) | | | | |
| Ratio (H2 − H1)/ | 0.5 | 0.5 | 0.5 | 0.5 |
| (H3 − H1) | | | | |
| Length of flat | 0.15 | 0.15 | 0.15 | 0.15 |
| portion (mm) | | | | |
| Ratio RH/Lb | 0.27 | 0.27 | 0.27 | 0.27 |
| Ratio LH/SH | 0.3 | 0.3 | 0.3 | 0.3 |
| Ratio AH/SH | 0.4 | 0.4 | 0.4 | 0.4 |
| Angle θr (deg) | 70 | 70 | 70 | 70 |
| Angle θc (deg) | 0 | 0 | 0 | 0 |
| Ridge surface roughness | 1 | 2 | 4 | 5 |
| Ra (μ/m) | | | | |
| Protrusion height of | 0.8 | 0.8 | 0.8 | 0.8 |
| protrusion portions (mm) | | | | |
| Contact angle of serration | 62 | 60 | 60 | 62 |
| region (deg) | | | | |
| Cleaning performance | 8 | 8.5 | 8.5 | 8 |
| (score) | | | | |
| Visibility performance | 113 | 114 | 114 | 113 |
| (score) | | | | |

TABLE 10-1

| | Exam | Exam- | Exam- | Exam- |
|---|---|---|---|---|
| | ple 83 | ple 84 | ple 85 | ple 86 |
| Length Lb (mm) | 0.6 | 0.6 | 0.6 | 0.6 |
| Height ratio H2/H1 | 1.3 | 1.3 | 1.3 | 1.3 |
| Ratio Lr/Lb | 1.65 | 1.65 | 1.65 | 1.65 |
| Ratio W2/W1 | 0.17 | 0.17 | 0.17 | 0.17 |
| Ratio W3/W1 | 0.13 | 0.13 | 0.13 | 0.13 |
| Difference between | 0.06 | 0.06 | 0.06 | 0.06 |
| H1 and H3 (mm) | | | | |
| Ratio (H2 − H1)/ | 0.5 | 0.5 | 0.5 | 0.5 |
| (H3 − H1) | | | | |
| Length of flat | 0.15 | 0.15 | 0.15 | 0.15 |
| portion (mm) | | | | |
| Ratio RH/Lb | 0.27 | 0.27 | 0.27 | 0.27 |
| Ratio LH/SH | 0.3 | 0.3 | 0.3 | 0.3 |
| Ratio AH/SH | 0.4 | 0.4 | 0.4 | 0.4 |
| Angle θr (deg) | 70 | 70 | 70 | 70 |
| Angle θc (deg) | 0 | 0 | 0 | 0 |
| Ridge surface roughness | 3 | 3 | 3 | 3 |
| Ra (μ/m) | | | | |
| Protrusion height | 0.2 | 0.5 | 0.7 | 1.0 |
| of protrusion | | | | |
| portions (mm) | | | | |
| Contact angle of serration | 62 | 62 | 62 | 62 |
| region (deg) | | | | |
| Cleaning performance | 8.5 | 8.5 | 8.5 | 8 |
| (score) | | | | |
| Visibility performance | 117 | 116 | 115 | 114 |
| (score) | | | | |

TABLE 10-2

| | Example | Example | Example |
|---|---|---|---|
| | 87 | 88 | 89 |
| Length Lb (mm) | 0.6 | 0.6 | 0.6 |
| Height ratio H2/H1 | 1.3 | 1.3 | 1.3 |
| Ratio Lr/Lb | 1.65 | 1.65 | 1.65 |
| Ratio W2/W1 | 0.17 | 0.17 | 0.17 |
| Ratio W3/W1 | 0.13 | 0.13 | 0.13 |
| Difference between | 0.06 | 0.06 | 0.06 |
| H1 and H3 (mm) | | | |
| Ratio (H2 − H1)/ | 0.5 | 0.5 | 0.5 |
| (H3 − H1) | | | |
| Length of flat | 0.15 | 0.15 | 0.15 |
| portion (mm) | | | |
| Ratio RH/Lb | 0.27 | 0.27 | 0.27 |
| Ratio LH/SH | 0.3 | 0.3 | 0.3 |
| Ratio AH/SH | 0.4 | 0.4 | 0.4 |
| Angle θr (deg) | 70 | 70 | 70 |
| Angle θc (deg) | 0 | 0 | 0 |
| Ridge surface roughness | 10 | 1 | 1 |
| Ra (μ/m) | | | |
| Protrusion height | 0.8 | 0.8 | 0.15 |
| of protrusion | | | |
| portions (mm) | | | |
| Contact angle of serration | 64 | 62 | 62 |
| region (deg) | | | |
| Cleaning performance | 8 | 8 | 8.5 |
| (score) | | | |
| Visibility performance | 113 | 114 | 116 |
| (score) | | | |

1. A pneumatic tire comprising a tread portion; a sidewall portion; and a bead portion,
a serration region being provided in a predetermined region of the sidewall portion,
the serration region being formed by arranging a plurality of ridges,
the plurality of ridges protruding from a base surface in parallel to each other and periodically, when a length along a contour of the ridge per cycle in a cross-sectional view along a direction orthogonal to an extension direction of the plurality of ridges is defined as a length Lr and a length of one cycle of the plurality of ridges along the base surface is defined as a length Lb, a ratio Lr/Lb of the length Lr to the length Lb being 1.2 or more and 2.0 or less, and
the length Lb being 0.5 mm or more and 0.7 mm or less.

2. The pneumatic tire according to claim 1, wherein an opening width La between the ridges that are adjacent is 0.15 mm or more and 0.35 mm or less in a cross-sectional view along a direction orthogonal to an extension direction of the ridge.

3. The pneumatic tire according to claim 2, wherein a ratio La/Lb of the opening width La to the length Lb is 0.3 or more and 0.6 or less.

4. A pneumatic tire comprising a tread portion; a sidewall portion; and a bead portion,
a serration region being provided in a predetermined region of the sidewall portion,
the serration region being formed by arranging a plurality of ridges,
the plurality of ridges protruding from a base surface in parallel to each other and periodically,
a length Lb of one cycle of the plurality of ridges along the base surface being 0.5 mm or more and 0.7 mm or less,
in a cross-sectional view along a direction orthogonal to an extension direction of the plurality of ridges,
a plurality of recess portions being provided on a top surface of each of the plurality of ridges,
a bottom flat portion with no unevenness being provided on a bottom surface of the recess portion,
an inter-recess flat portion with no unevenness being provided between the recess portions that are adjacent, and
a ratio H2/H1 of a height H2 from the base surface to the inter-recess flat portion to a height H1 from the base surface to the bottom flat portion being 1.2 or more and 1.6 or less.

5. The pneumatic tire according to claim 4, wherein, when a length along a contour of the ridge per cycle in a cross-sectional view along a direction orthogonal to an extension direction of the plurality of ridges is defined as a length Lr, a ratio Lr/Lb of the length Lr to the length Lb is 1.2 or more and 2.0 or less.

6. The pneumatic tire according to claim 4, wherein in a cross-sectional view along a direction orthogonal to an extension direction of the ridge, a ratio W2/W1 of an opening width W2 of the top surface of the recess portion to a width W1 of the top surface of the ridge is 0.1 or more and 0.3 or less, and a ratio W3/W1 of a width W3 of the recess portion to the width W1 of the top surface of the ridge is 0.05 or more and 0.25 or less.

7. The pneumatic tire according to claim 4, wherein a difference between a height H1 from the base surface to the bottom flat portion and a height H3 from the base surface to a maximum height position of the top surface of the ridge is 0.03 mm or more and 0.15 mm or less.

8. The pneumatic tire according to claim 4, wherein a ratio (H2−H1)/(H3−H1) of a difference between a height H2 from the base surface to the inter-recess flat portion and a height H1 from the base surface to the bottom flat portion to a difference between a height H3 from the base surface to a maximum height position of the top surface of the ridge and the height H1 from the base surface to the bottom flat portion is 0.2 or more and 0.6 or less.

9. The pneumatic tire according to claim 1, wherein
the base surface comprises a flat portion having no unevenness,
the flat portion is a straight line in a cross-sectional view along a direction orthogonal to an extension direction of the ridge, and
a length of the straight line is 0.15 mm or more.

10. The pneumatic tire according to claim 1, wherein a ratio RH/Lb, to the length Lb, of a height RH from the base surface to a maximum projection position of the ridge is 0.11 or more and 0.3 or less.

11. The pneumatic tire according to claim 1, wherein in a tire meridian cross-section, a ratio LH/SH, to a tire cross-sectional height SH, of a length LH in a tire radial direction of a range in the tire radial direction of the serration region is 0.2 or more and 0.4 or less.

12. The pneumatic tire according to claim 1, wherein in a tire meridian cross-section, when a height along a tire radial direction from a measurement point of a rim diameter of a rim on which the pneumatic tire is mounted to a position on an inner side of the serration region in the tire radial direction is defined as AH, a ratio AH/SH of the height AH to a tire cross-sectional height SH is 0.3 or more and 0.5 or less.

13. The pneumatic tire according to claim 1, wherein an angle θr between a flat portion of the base surface having no unevenness and a wall surface of the ridge is 60° or more and 85° or less.

14. The pneumatic tire according to claim 1, wherein an angle θc in an extension direction of the ridge with respect to a tire radial direction is within a range of ±20° with respect to the tire radial direction.

15. The pneumatic tire according to claim 1, wherein a surface of a member forming a contour of the ridge has a hydrophilic property.

16. The pneumatic tire according to claim 1, wherein an arithmetic mean roughness Ra of rubber on a surface of the ridge is 0.1 μm or more and 5 μm or less.

17. The pneumatic tire according to claim 1, wherein the base surface is a surface recessed from a tire profile toward a tire cavity side.

18. The pneumatic tire according to claim 1, further comprising a first protrusion portion extending in a tire circumferential direction at a position on an outer side of the serration region in a tire radial direction, and a second protrusion portion extending in the tire circumferential direction at a position on an inner side of the serration region in the tire radial direction.

19. The pneumatic tire according to claim 18, wherein a protrusion height of the first protrusion portion and of the second protrusion portion from a tire profile is 0.7 mm or less.

20. The pneumatic tire according to claim 1, wherein the ridge is trapezoidal in a cross-sectional view along a direction orthogonal to an extension direction of the ridge.
